(19) United States
(12) Patent Application Publication
(10) Pub. No.: US 2023/0416932 A1
(43) Pub. Date: Dec. 28, 2023

(54) ELECTROLYZER

(71) Applicant: Washington University, St. Louis, MO (US)

(72) Inventors: Shrihari Sankarasubramanian, St. Louis, MO (US); Pralay Gayen, St. Louis, MO (US); Vijay Ramani, St. Louis, MO (US); Sulay Saha, St. Louis, MO (US)

(21) Appl. No.: 18/466,073

(22) Filed: Sep. 13, 2023

Related U.S. Application Data
(63) Continuation-in-part of application No. 18/005,867, filed on Jan. 18, 2023.
(60) Provisional application No. 63/054,356, filed on Jul. 21, 2020.
(60) Provisional application No. 63/377,140, filed on Sep. 26, 2022.

(51) Int. Cl. C25B 9/19; C25B 11/067; C25B 11/075; H01M 4/90; H01M 8/18; C25B 1/04

(52) U.S. Cl. CPC C25B 9/19; C25B 11/067; C25B 11/075; H01M 4/9075; H01M 8/18; C25B 1/04

(57) ABSTRACT

Described herein is an electrolyzer including a pyrochlore electrocatalyst with a metal deposited thereon. The electrolyzer may be a unitized regenerative fuel cell. Also described herein are methods of using the electrolyzer. Also described herein is a brine electrolyzer including a pyrochlore electrocatalyst. Also described herein are methods of using the brine electrolyzer.

### CROSS-REFERENCE TO RELATED APPLICATIONS

This application claims priority to U.S. Provisional Application Ser. No. 63/377,140, filed on Sep. 26, 2022, and is a continuation-in-part application of U.S. patent applicant Ser. No. 18/005,867, filed Jan. 18, 2023, which is a U.S. National Phase Application of International Patent Application No. PCT/US21/42536, filed Jul. 21, 2021, which claims priority to U.S. Provisional Application Ser. No. 63/054,356, filed on Jul. 21, 2020, the contents of each of which are hereby incorporated by reference in their entirety.

### FIELD OF THE DISCLOSURE

Described herein is an electrolyzer including a pyrochlore electrocatalyst or a pyrochlore electrocatalyst with a metal deposited thereon. The electrolyzer may be a unitized regenerative fuel cell. The electrolyzer may be a brine electrolyzer. Also described herein are methods of using the electrolyzer.

### BACKGROUND OF THE DISCLOSURE

Water electrolysis using renewable energy sources has been recognized as one of the most promising techniques for hydrogen and oxygen production with minimal environmental consequences. Water electrolysis is primarily done through a proton-exchange-membrane (PEM) or alkaline electrolyzer. However, these systems require high purity water feeds and such feeds substantially increase operational costs.

High-performance alkaline water electrolyzers using Pb₂Ru₂O_{7-δ} as oxygen evolution reaction (OER) electrocatalysts are known. The activity of such electrocatalysts for both O₂ reduction as well as evolution reactions is well established. A shift from low pH operation to high pH, by alkaline operation, is advantageous because it enables the replacement of expensive platinum or iridium based catalysts with economical alternatives. In the present disclosure, the use of Pb₂Ru₂O_{7-δ} and other pyrochlore catalysts allows a significant reduction in the amount of platinum group metal (PGM) used in a given electrolyzer cell.

One possible way to reduce costs is to replace high purity water with briny or brackish water in the electrolyzer. Using briny or brackish water also increases availability of water sources and allows application of water electrolyzers with unconventional water sources, such as seawater or extraterrestrial liquid water. Use of seawater would provide an abundant resource for terrestrial energy production. Use of extraterrestrial liquid water would provide an on-site resource to produce life support O₂ and fuel H₂. The use of brine will also enable use of wastewater from a variety of industrial sources and power plants as the feed source for this electrolyzer. The dissolved salts in the electrolyzer reduce the overall cell voltage, thereby improving its energy efficiency.

The electrolyzers using briny or brackish water could be particularly useful in space exploration. It is well known that life support O₂ and fuel such as H₂ are indispensable for human space exploration. The electrolysis of extraterrestrial liquid water can be a significant concurrent source of H₂ and O₂.

The United States National Aeronautics and Space Administration's (NASA) Phoenix lander has found evidence of an active water cycle, extensive sub-surface ice, and the presence of soluble perchlorates on the Martian surface. Spectral evidence from the Mars Odyssey Gamma Ray Spectrometer (GRS) points to the existence of large quantities of water-ice in the northern polar region of Mars and the Mars Reconnaissance Orbiter (MRO) has also found indications of contemporary local flows of liquid regolithic brines shaping Martian geography. Martian regolithic brines with dissolved perchlorates exist in the liquid phase since perchlorates significantly depress the freezing point of water. Based on compositional analysis by the wet chemistry instrument (WCI) on the Phoenix lander, Mg(ClO₄)₂ is reported to be a major constituent of the Martian regolith and its concentrated solutions remain in the liquid phase up to about −70° C. This offers a temperature window for the existence of liquid brine on the Martian surface and subsurface as the mean annual terrestrial temperature on Mars is about −63° C. with a wide (>100° C.) average diurnal variation. The hygroscopic nature of these perchlorates also enables the entrainment of atmospheric water vapor to produce concentrated brine solutions.

The Martian atmosphere significantly differs from that of Earth's, with its predominant constituent being CO₂. CO₂ reduction has been shown to be unlikely in similar perchlorate electrolytes. Although the atmospheric pressure on Mars (6.4 mbar) is significantly lower than that of Earth (1013 mbar), highly concentrated Mg(ClO₄)₂ solutions remain in the liquid phase under Martian temperature and pressure conditions.

Regolithic brine electrolysis under Martian conditions is demonstrated herein. Such an electrolysis will enable the production of ultra-pure O₂ for life-support and H₂ for energy production, with no additional purification requirement for CO removal. The H₂ produced in tandem can serve as a clean burning fuel with a superior calorific value to CO. This electrolyzer system has a 25-fold higher production rate of O₂, when compared to NASA's Mars Oxygen In-Situ Resource Utilization Experiment (MOXIE), while consuming the same amount of power. As such, this system consumes 25 times less power than MOXIE for the same O₂ production rate.

In this perspective, described herein is a brine electrolyzer that electrochemically splits brine to produce hydrogen at the cathode and oxygen at the anode. Advantages of the present brine electrolyzer include device operation at near-neutral pH (thereby avoiding the material challenges encountered when operating in acidic or alkaline conditions), device operation without the need for a deionized water feed (by either using briny/brackish water feeds or by the deliberate addition of perchlorate salts to the input feed to enhance performance), and the use of selective catalysts at the anode that favor oxygen evolution and mitigate the occurrence of unwanted side reactions including, but not limited to, chlorine evolution.

Relatedly, energy storage has gained increased attention for flexible electrical grid operation as conventional constant and variable energy sources converge on the electrical grid. In this context, hydrogen has emerged as a clean energy carrier/source (energy density: 120-142 MJ/kg) which is produced via water splitting in an electrolyzer using external power source. The generated hydrogen is used as a fuel in a fuel cell to convert chemical energy into electrical energy. Combining fuel cell and electrolyzer in a single device, known as a regenerative fuel cell (RFC), offers certain advantages over conventional rechargeable batteries (RBs) such as fast start-up/shut down, low self-discharge, low environmental effect, high energy density and long duration/lifetime. To date, RFCs have been extensively used for unmanned underwater vehicles, high altitude long-duration aircraft, off-grid power storage, and emergency power generators. Unitized regenerative fuel cells (URFCs) is the modification of RFCs which offer the same benefits as RFCs with less weight, less volume and less capital cost as a single cell (fuel cell+electrolyzer) in URFC does not require auxiliary equipment for an additional cell stack used in the RFCs. Despite the wide application of proton exchange membrane-URFCs (PEM-URFCs) for their high power density, anion exchange membrane (AEM)-URFCs have gained attention due to their cost-effectiveness as use of costly noble metals with high loading can be avoided. Typically the URFCs have two different configurations: 1) fixed gas (FG-URFC) where oxygen evolution reaction (OER) and oxygen reduction reaction (ORR) happen at one electrode (oxygen electrode) whereas hydrogen evolution reaction (HER) and hydrogen oxidation reaction (HOR) occur on the other electrode (hydrogen electrode) under water electrolyzer (WE) and fuel cell (FC) mode, respectively and 2) fixed polarity (FP-URFC) where OER (WE mode) and HOR (FC mode) occur at the same electrode whereas HER (WE mode) and ORR (FC mode) occur at the other. The FG-URFCs offer the advantage of efficient and easy gas management over FP-URFCs. However, FG-URFCs suffer from sluggish oxygen electrode reactions (ORR during FC mode and OER during WE mode) on the same side of the cell resulting in a convergence of inefficiencies which act as a bottleneck for the wide application of AEM FG-URFCs. Therefore, the development of highly active ORR/OER bifunctional electrocatalysts is necessary for AEM FG-URFCs. An ideal bifunctional oxygen electrocatalyst should show converging OER and ORR onset potential towards an equilibrium potential of 1.23 V vs RHE with a low bifunctionality index (BI=difference between OER potential at 10 mA/cm²_{geo} and ORR potential at −3.0 mA/cm²_{geo}). However, benchmark OER (RuO₂ and IrO₂) and ORR (Pt) electrocatalyst exhibit a BI greater than 1.0 V making them unsuitable individually for use in URFC. Hence, they are used along with other electrocatalyst which can reduce their asymmetric electrocatalytic behavior (e.g. Pt-IrO2-(RuO₂—TiO₂ (RTO)), Pt—IrO₂, Pt—Ru—Ir). The use of AEM URFC enables expansion of the material space of electrocatalysts as a wide spectrum of materials is stable in alkaline medium.

In this context, an OER electrocatalyst which can also act as a support, in lieu of benchmark ORR electrocatalyst Pt, could be a good candidate as a bifunctional oxygen electrocatalyst. The support-material for Pt plays a critical role as it should provide high surface area, high OER activity, high OER-ORR stability, high electronic charge transport, efficient catalyst dispersion and help in facet engineering. The most commonly used catalyst supports are Vulcan XC-72, TiC, RTO, Sb-doped SnO₂ (ATO), doped-TiO₂, metal, and TiₙO₂ₙ₋₁ which offer moderate to high conductivity and moderate surface area, but offers no OER activity of note, thereby effectively ruling them out. In this regard, use of alkaline OER-active and OER/ORR-stable electrocatalyst as a support for Pt could be a solution. Among them, lead ruthenate pyrochlore (Pb₂Ru₂O₇₋ₓ) has shown excellent OER activity-stability and moderate ORR activity-stability in alkaline medium.

In this perspective, in this disclosure, Pt has been deposited on Pb₂Ru₂O₇₋ₓ which shows a very low BI with highly symmetric OER-ORR activity profile making it useful for the alkaline-URFC as well as metal air battery applications. Pt—Pb₂Ru₂O₇₋ₓ exhibits higher OER and ORR activity in comparison to IrO₂ and Pt/C, respectively. The high OER activity is ascribed to a high Ru(V):Ru(IV) ratio in Pt—Pb₂Ru₂O₇₋ₓ which is confirmed through XPS study. The high ORR activity of Pt—Pb₂Ru₂O₇₋ₓ is attributed to the high dispersion of Pt on Pb₂Ru₂O₇₋ₓ support. A FG-URFC tested with Pt—Pb₂Ru₂O₇₋ₓ and Pt/C as bifunctional oxygen electrocatalyst and bifunctional hydrogen electrocatalyst, respectively yields a mass-specific current density of 715±11 A g⁻¹ at 1.8 V and 56±2 A g_{cat}⁻¹ at 0.9 V under electrolyzer mode and fuel cell mode, respectively. The FG-URFC shows a round-trip efficiency (RTE) of 75% at 0.1 A cm⁻² which is the highest known RTE in an AEM FG-URFC, thereby signifying the usefulness of Pt—Pb₂Ru₂O₇₋ₓ as OER/ORR bifunctional electrocatalyst for future energy and fuel production applications.

### BRIEF DESCRIPTION OF THE DISCLOSURE

In one embodiment, the present disclosure is directed to an electrolytic cell comprising a cathode, an anode comprising a pyrochlore, an ion exchange membrane separating the cathode and the anode, and a brine solution in contact with the anode and the cathode, wherein the brine solution optionally comprises a perchlorate salt.

In another embodiment, the present disclosure is directed to a method of using an electrolytic cell. The method comprises using the electrolytic cell to produce H₂ and O₂ from a brine solution, wherein the electrolytic cell comprises a cathode, an anode comprising a pyrochlore, an ion exchange membrane separating the cathode and the anode, and a brine solution in contact with the anode and the cathode, wherein the brine solution optionally comprises a perchlorate salt.

In another embodiment, the present disclosure is directed to an electrolytic cell comprising a cathode, an anode comprising a pyrochlore comprising a metal deposited thereon, and an ion exchange membrane separating the cathode and the anode.

In another embodiment, the present disclosure is directed to a method of using an electrolytic cell. The method comprises using the electrolytic cell as an electrolyzer and/or a fuel cell, wherein the electrolytic cell comprises a cathode, an anode comprising a pyrochlore comprising a metal deposited thereon, and an ion exchange membrane separating the cathode and the anode.

### BRIEF DESCRIPTION OF THE DRAWINGS

FIG. 1A is an exemplary embodiment of an LSV of Pb₂Ru₂O_{7-δ} pyrochlore, RuO₂, and GC at 21° C. in accordance with the present disclosure.

FIG. 1B is an exemplary embodiment of an LSV of Pb₂Ru₂O_{7-δ} pyrochlore, RuO₂, and GC at −36° C. in accordance with the present disclosure.

FIG. 1C is an exemplary embodiment of an LSV of Pb₂Ru₂O_{7-δ} pyrochlore, RuO₂, and GC in accordance with the present disclosure.

FIG. 2A is an exemplary embodiment of a schematic of a brine electrolyzer in accordance with the present disclosure.

FIG. 2B is an exemplary embodiment of electrolyzer polarization (E vs. j) and tandem H₂ (red circle)/O₂ (blue triangle) production rate under a simulated Martian environment in accordance with the present disclosure.

FIG. 3A is an exemplary embodiment of efficiency of an electrolyzer in accordance with the present disclosure at 21° C. and −36° C.

FIG. 3B is an exemplary embodiment of stability of an electrolyzer in accordance with the present disclosure at 21° C. and −36° C.

FIG. 4 is an exemplary embodiment of O₂ production as a function of power consumption electrolyzer volume and electrolyzer weight vs. power consumption for different consumption rates for an electrolyzer in accordance with the present disclosure.

FIG. 5A is an exemplary embodiment of XPS spectra of O is of Pb₂Ru₂O_{7-δ} in accordance with the present disclosure.

FIG. 5B is an exemplary embodiment of XPS spectra of Ru 3p of Pb₂Ru₂O_{7-δ} in accordance with the present disclosure.

FIG. 5C is an exemplary embodiment of XPS spectra of Pb 4f of Pb₂Ru₂O_{7-δ} in accordance with the present disclosure.

FIG. 6A is an exemplary embodiment of an OER LSV of Pb₂Ru₂O_{7-δ} under O₂ purged SMRB and over a range of temperatures (21° C. to −36° C.) in accordance with the present disclosure.

FIG. 6B is an exemplary embodiment of an OER LSV of RuO₂ under O₂ purged SMRB and over a range of temperatures (21° C. to −36° C.) in accordance with the present disclosure.

FIG. 6C is an exemplary embodiment of an OER LSV of glassy carbon (GC) under O₂ purged SMRB and over a range of temperatures (21° C. to −36° C.) in accordance with the present disclosure.

FIG. 7A is an exemplary embodiment of an OER LSV of Pb₂Ru₂O_{7-δ} pyrochlore under CO₂ purged SMRB and over a range of temperatures (21° C. to −36° C.) in accordance with the present disclosure.

FIG. 7B is an exemplary embodiment of an OER LSV of Pb₂Ru₂O_{7-δ} pyrochlore under O₂ purged SMRB and over a range of temperatures (21° C. to −36° C.) in accordance with the present disclosure.

FIG. 8A is an exemplary embodiment of Tafel slopes of Pb₂Ru₂O_{7-δ}, RuO₂ and GC under O₂- and CO₂-purged SMRB at 21° C. in accordance with the present disclosure.

FIG. 8B is an exemplary embodiment of Tafel slopes of Pb₂Ru₂O_{7-δ}, RuO₂ and GC under O₂- and CO₂-purged SMRB at −36° C. in accordance with the present disclosure.

FIG. 8C is an exemplary embodiment of Tafel slopes of Pb₂Ru₂O_{7-δ} under CO₂-purged SMRB at different temperatures in accordance with the present disclosure.

FIG. 8D is an exemplary embodiment of Tafel slopes of Pb₂Ru₂O_{7-δ} under O₂-SMRB at different temperatures in accordance with the present disclosure.

FIG. 9 is a proposed, non-limiting reaction scheme for the ORR in acidic and near-neutral environments in accordance with the present disclosure.

FIG. 10 is an exemplary embodiment of ORR current density at 200 mV overpotential vs. onset potential for Pb₂Ru₂O_{7-δ} and GC at O₂-purged SMRB at different temperatures in accordance with the present disclosure.

FIG. 11 is an exemplary embodiment of Tafel slopes for HER with Pt/C in CO₂-purged SMRB at different temperatures in accordance with the present disclosure.

FIG. 12 is an exemplary embodiment of the resistance and conductivity of the electrolytic solution at different temperatures in accordance with the present disclosure.

FIG. 13 is an exemplary embodiment of an SMRB electrolyzer polarization curve (diamonds), O₂ production (triangles) and H₂ production (circles) at 21° C. in accordance with the present disclosure.

FIG. 14 is an exemplary embodiment of an XRD spectrum of a prepared Pb₂Ru₂O_{7-δ} pyrochlore sample in accordance with the present disclosure.

FIG. 15 is an exemplary embodiment of an SEM image of a prepared Pb₂Ru₂O_{7-δ} sample in accordance with the present disclosure.

FIG. 16A is an exemplary embodiment of a layered EDAX image of a prepared pyrochlore sample in accordance with the present disclosure.

FIG. 16B is an exemplary embodiment of elemental mapping of O on a layered EDAX image of a prepared pyrochlore sample in accordance with the present disclosure.

FIG. 16C is an exemplary embodiment of elemental mapping of Ru on a layered EDAX image of a prepared pyrochlore sample in accordance with the present disclosure.

FIG. 16D is an exemplary embodiment of elemental mapping of Pb on a layered EDAX image of a prepared pyrochlore sample in accordance with the present disclosure.

FIG. 17A is an exemplary embodiment of a scanning electron microscope (SEM) image of Pb₂Ru₂O₇₋ₓ in accordance with the present disclosure.

FIG. 17B is an exemplary embodiment of a scanning electron microscope (SEM) image of Pt—Pb₂Ru₂O₇₋ₓ in accordance with the present disclosure.

FIG. 17C is an exemplary embodiment of energy dispersive x-ray (EDX) elemental mapping of Pb₂Ru₂O₇₋ₓ and Pt—Pb₂Ru₂O₇₋ₓ in accordance with the present disclosure.

FIG. 18 is an exemplary embodiment of X-ray powder diffraction (XRD) of a Pt—Pb₂Ru₂O₇₋ₓ sample and a Pb₂Ru₂O₇₋ₓ sample in accordance with the present disclosure.

FIG. 19A is an exemplary embodiment of linear sweep voltammetry (LSV) curves corresponding to OER and ORR on Pb₂Ru₂O₇₋ₓ, Pt—Pb₂Ru₂O₇₋ₓ, IrO₂ and Pt/C in 0.1 M KOH solution at 1600 rpm in accordance with the present disclosure.

FIG. 19B is an exemplary embodiment of OER Tafel slopes for all the electrocatalysts, with catalyst loading=200 μg cm⁻², in accordance with the present disclosure.

FIG. 19C is an exemplary embodiment of ORR Tafel slopes for all the electrocatalysts, with catalyst loading=200 μg cm⁻², in accordance with the present disclosure.

FIG. 19D is an exemplary embodiment of the activation barrier involving each electron transfer during OER on Pb₂Ru₂O_{6.5} (111) facet and Pt (111) facet in accordance with the present disclosure. ‘S’ corresponds to the active site.

FIG. 20A is an exemplary embodiment of linear sweep voltammetry (LSV) curves of Pt—Pb₂Ru₂O₇₋ₓ before and after the OER-hold test (1.7 V vs RHE for 2 h) in accordance with the present disclosure.

FIG. 20B is an exemplary embodiment of linear sweep voltammetry (LSV) curves of Pt—Pb₂Ru₂O₇₋ₓ before and after the ORR-hold test (0.5 V vs RHE for 2 h) in accordance with the present disclosure.

FIG. 21 is an exemplary embodiment of the FG-URFC performance (WE and FC) using Pt—Pb₂Ru₂O₇₋ₓ, Pt/C and Fumasep FAA-3-50 as anode, cathode and separator, respectively, in accordance with the present disclosure. The anode and cathode remain unchanged for both fuel cell and electrolyzer mode.

FIG. 22A is an exemplary embodiment of X-ray photoelectron spectroscopy (XPS) of the Ru 3d region of Pb₂Ru₂O₇₋ₓ in accordance with the present disclosure.

FIG. 22B is an exemplary embodiment of X-ray photoelectron spectroscopy (XPS) of the Pb 4f region of Pb₂Ru₂O₇₋ₓ in accordance with the present disclosure.

FIG. 22C is an exemplary embodiment of X-ray photoelectron spectroscopy (XPS) of the O 1 region of Pb₂Ru₂O₇₋ₓ in accordance with the present disclosure.

FIG. 23A is an exemplary embodiment of X-ray photoelectron spectroscopy (XPS) of the Ru 3d region of Pt—Pb₂Ru₂O₇₋ₓ in accordance with the present disclosure.

FIG. 23B is an exemplary embodiment of X-ray photoelectron spectroscopy (XPS) of the Pb 4f region of Pt—Pb₂Ru₂O₇₋ₓ in accordance with the present disclosure.

FIG. 23C is an exemplary embodiment of X-ray photoelectron spectroscopy (XPS) of the O 1 region of Pt—Pb₂Ru₂O₇₋ₓ in accordance with the present disclosure.

FIG. 23D is an exemplary embodiment of X-ray photoelectron spectroscopy (XPS) of the Pt 4f region of Pt—Pb₂Ru₂O₇₋ₓ in accordance with the present disclosure.

FIG. 24 is an exemplary embodiment of cyclic voltammetry (CV) measurements of Pt/C and Pt—Pb₂Ru₂O₇₋ₓ for ECSA measurement through H-UPD in accordance with the present disclosure.

FIG. 25 is an exemplary embodiment of electrochemical active surface area (ECSA) measurements of Pt—Pb₂Ru₂O₇₋ₓ at the start of the hold-test (pristine), after 2 h OER-hold test and (2 h+2 h) OER-ORR hold-test in accordance with the present disclosure.

FIG. 26A is an exemplary embodiment of a transmission electron microscopy (TEM) image of Pt—Pb₂Ru₂O₇₋ₓ before 10 consecutive URFC cycles.

FIG. 26B is an exemplary embodiment of a transmission electron microscopy (TEM) image of Pt—Pb₂Ru₂O₇₋ₓ after 10 consecutive URFC cycles.

### DETAILED DESCRIPTION OF THE DISCLOSURE

Brine Electrolyzer.

Described herein is an electrolytic cell comprising a cathode, an anode comprising a pyrochlore, an ion exchange membrane separating the cathode and the anode, and a brine solution in contact with the anode and the cathode. The brine solution optionally comprises a perchlorate salt.

As used herein, a pyrochlore is a compound having the pyrochlore crystal structure (Fd3̅m).

In some embodiments, the pyrochlore comprises oxygen and at least two different rare earth or transition metal species.

In some embodiments, the pyrochlore is a compound according to Formula I.

A¹ₓA²₂₋ₓB¹_{y}B²_{2-y}O_{7-z} (I),

wherein A¹ and A² are each independently selected from the group consisting of Pb, Y, La, Gd, Bi, Dy, Cd, Tl, and Ca; B¹ and B² are each independently selected from the group consisting of Ru, Ir, Rh, Re, Sn, Ti, Pt, Os, Zr, and Pd; x is a value between 0 and 2; y is a value between 0 and 2; and z is a value between 0 and 1.

In some embodiments, x is selected from the group consisting of 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, and 2.0.

In some embodiments, y is selected from the group consisting of 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, and 2.0.

In some embodiments, z is selected from the group consisting of 0, 0.1, 0.2, 0.3, 0.4, 0.5, 0.6, 0.7, 0.8, 0.9, and 1.0.

In some embodiments, the pyrochlore is a compound according to Formula II:

A²B₂O_{7-z} (II),

wherein A is selected from the group consisting of Pb, Y, La, Gd, Bi, Dy, Cd, and Tl; B is selected from the group consisting of Ru, Ir, Rh, Sn, Ti, Pt, Os, and Pd; and z is a value between 0 and 1.

In some embodiments, A is Pb.

In some embodiments, B is Ru.

In some embodiments, z is selected from the group consisting of 0, 0.1, 0.2, 0.3, 0.4, 0.5, 0.6, 0.7, 0.8, 0.9, and 1.0.

In some embodiments, the pyrochlore is Pb₂Ru₂O_{7-z}.

In some embodiments, the pyrochlore does not comprise Bi. In some embodiments, the pyrochlore is essentially free of Bi. In some embodiments, the pyrochlore being essentially free of Bi means that the pyrochlore comprises less than about 5% of Bi.

In some embodiments, the cathode comprises a catalyst selected from the group consisting of Pt, Pd, alloys of Pt and alloys of Pd supported on C, RuO₂, Ni(OH)₂, TiO₂, SnO₂, TiO₂ with Nb or Ru dopants, SnO₂ with Sb or Ta dopants, and combinations thereof. Suitable alloys of Pd supported on C are described in U.S. Pat. No. 9,799,881, which is incorporated by reference herein.

In some embodiments, the cathode comprises a Pt/C catalyst. In some embodiments, the cathode comprises a Pt/RuO₂—TiO₂ catalyst. In some embodiments, the cathode comprises a Pt/C/Ni(OH)₂ catalyst.

As used herein, brine is a solution comprising water and relatively high concentrations of NaCl. In some embodiments, brine is a solution comprising water, relatively high concentrations of NaCl, and perchlorate salts. In some embodiments, brine is a solution comprising a salt comprising (i) at least one cation selected from the group consisting of lithium, sodium, potassium, barium, calcium, magnesium and ammonium; and (ii) at least one anion selected from the group consisting of chloride, perchlorate, sulfate, carbonate, bicarbonate and nitrate.

In some embodiments, the brine is brackish water. In some embodiments, the brine has a NaCl concentration in the range of from about 0.05% to about 3%, from about 0.10% to about 2%, or from about 0.15% to about 1%.

In some embodiments, the brine is saline water. In some embodiments, the brine has a NaCl concentration in the range of from about 3% to about 5%.

In some embodiments, the brine is seawater. In some embodiments, the brine has a NaCl concentration of about 3.5%.

In some embodiments, the brine is a saturated brine. In some embodiments, the brine has a NaCl concentration in the range of from about 5% to about 28%, from about 10% to about 25%, or from about 15% to about 20%. In some embodiments, the brine has a NaCl concentration greater than about 28%.

In some embodiments, the brine solution comprises a perchlorate salt. The perchlorate salt improves the electrolyte conductivity without blocking the catalytic reaction sites, thereby improving cell performance.

In some embodiments, the brine solution comprises a perchlorate salt in a concentration in the range of from about 0.1M to about 3M, from about 0.5M to about 2M, or from about 0.75M to about 1.5M.

In some embodiments, the electrolytic cell comprises a perchlorate salt selected from the group consisting of Mg(ClO₄)₂, Ca(ClO₄)₂, NaClO₄, salts of Li, Ba, K, and Mg, and combinations thereof.

In some embodiments, the brine solution comprises CO₂. In some embodiments, the CO₂ is added to the brine solution. In some embodiments, the brine solution comprises CO₂ that is added to a natural brine solution. In some embodiments, the brine solution naturally comprises CO₂. Brine solutions that naturally include CO₂ may include CO₂ dissolved from the atmosphere. In some embodiments, the brine solution comprises CO₂ at a concentration in the range of from about 0.0001M to about 3M.

In some embodiments, the brine solution has a neutral pH or a near neutral pH.

In some embodiments, the brine solution has a pH in the range of from about 7 to about 8.

In some embodiments, the ion exchange membrane is selected from the group consisting of an anion exchange membrane and a proton exchange membrane. In some embodiments, the ion exchange membrane is an anion exchange membrane. In some embodiments, the ion exchange membrane is selected from the group consisting of block copolymers, SEBS membranes, QPEK membranes, and combinations thereof.

In some embodiments, any suitable anion exchange membrane known in the art is used. Suitable anion exchange membranes include those described in US20190044158 and WO2020028374, which are incorporated by reference herein.

Also described herein is a method of using an electrolytic cell, wherein the electrolytic cell comprises a cathode, an anode comprising a pyrochlore, an ion exchange membrane separating the cathode and the anode, and a brine solution in contact with the anode and the cathode. The brine solution optionally comprises a perchlorate salt. The method comprises using the electrolytic cell to produce H₂ and O₂ from the brine solution.

In some embodiments, the method step of using the electrolytic cell to produce H₂ and O₂ from the brine solution comprises applying a current having a current density in the range of from about 500 mA/cm² to about 1500 mA/cm². In some embodiments, the method step of using the electrolytic cell to produce H₂ and O₂ from the brine solution comprises applying a current having a current density less than about 1000 mA/cm². In some embodiments, the method step of using the electrolytic cell to produce H₂ and O₂ from the brine solution comprises applying a current having a current density greater than about 1000 mA/cm² at below 2V cell voltage.

In some embodiments, the method step of using the electrolytic cell to produce H₂ and O₂ from the brine solution comprises using the electrolytic cell at a temperature in the range of from about −70° C. to about 40° C. In some embodiments, the method step of using the electrolytic cell to produce H₂ and O₂ from the brine solution comprises using the electrolytic cell at a temperature in the range of from about −70° C. to about 25° C. In some embodiments, the method step of using the electrolytic cell to produce H₂ and O₂ from the brine solution comprises using the electrolytic cell at a temperature in the range of from about −70° C. to about 0° C. In some embodiments, the method step of using the electrolytic cell to produce H₂ and O₂ from the brine solution comprises using the electrolytic cell at a temperature in the range of from about −70° C. to about −5° C. In some embodiments, the method step of using the electrolytic cell to produce H₂ and O₂ from the brine solution comprises using the electrolytic cell at a temperature in the range of from about −70° C. to about −20° C. In some embodiments, the method step of using the electrolytic cell to produce H₂ and O₂ from the brine solution comprises using the electrolytic cell at a temperature less than about −5° C.

In some embodiments, the method step of using the electrolytic cell to produce H₂ and O₂ from the brine solution comprises using the electrolytic cell at a temperature in the range of from about −5° C. to about 40° C. In some embodiments, the method step of using the electrolytic cell to produce H₂ and O₂ from the brine solution comprises using the electrolytic cell at a temperature in the range of from about 0° C. to about 40° C. In some embodiments, the method step of using the electrolytic cell to produce H₂ and O₂ from the brine solution comprises using the electrolytic cell at a temperature in the range of from about −5° C. to about 25° C.

In some embodiments, the H₂ and O₂ are concurrently produced. In some embodiments, the H₂ and O₂ are concurrently produced and are essentially free of Cl₂. In some embodiments, the H₂ and O₂ being concurrently produced and being essentially free of Cl₂ means that Cl₂ is produced in an amount less than about 10%, less than about 5%, less than about 3%, less than about 1%, less than about 0.5% or less than about 0.1% of the total products. In some embodiments, the H₂ and O₂ are concurrently produced and are essentially free of CO. In some embodiments, the H₂ and O₂ being concurrently produced and being essentially free of CO means that CO is produced in an amount less than about 10%, less than about 5%, less than about 3%, less than about 1%, less than about 0.5% or less than about 0.1% of the total products.

In some embodiments, the perchlorate salt is added to the brine solution. In some embodiments, the brine solution comprises a perchlorate salt that is added to a natural brine solution. In some embodiments, the brine solution is a terrestrial brine solution. In some embodiments, the brine solution is a seawater brine solution.

In some embodiments, the brine solution naturally comprises a perchlorate salt.

In some embodiments, the brine solution is an extraterrestrial liquid water brine solution. In some embodiments, the brine solution is a Martian liquid water brine solution.

In some embodiments, the brine solution is a mixture of a terrestrial brine solution and an extraterrestrial liquid water brine solution.

Regenerative Fuel Cell Including Pt-Pyrochlore as a Bifunctional Oxygen Electrocatalyst.

Described herein is an electrolytic cell comprising a cathode, an anode comprising a pyrochlore comprising a metal deposited thereon, and an ion exchange membrane separating the cathode and the anode.

In some embodiments, the electrolytic cell is a brine electrolyzer. In some embodiments, the electrolytic cell further comprises a brine solution in contact with the anode and the cathode, wherein the brine solution optionally comprises a perchlorate salt.

In some embodiments, the electrolytic cell is a unitized regenerative fuel cell. In some embodiments, the electrolytic cell is a fixed gas unitized regenerative fuel cell.

As used herein, a pyrochlore is a compound having the pyrochlore crystal structure (Fd3̅m).

In some embodiments, the pyrochlore comprises oxygen and at least two different rare earth or transition metal species.

In some embodiments, the pyrochlore is a compound according to Formula I:

A¹ₓA²₂₋ₓB¹_{y}B²_{2-y}O_{7-z} (I),

wherein A¹ and A² are each independently selected from the group consisting of Pb, Y, La, Gd, Bi, Dy, Cd, Tl, and Ca; B¹ and B² are each independently selected from the group consisting of Ru, Ir, Rh, Re, Sn, Ti, Pt, Os, Zr, and Pd; x is a value between 0 and 2; y is a value between 0 and 2; and z is a value between 0 and 1.

In some embodiments, x is selected from the group consisting of 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, and 2.0.

In some embodiments, y is selected from the group consisting of 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, and 2.0.

In some embodiments, z is selected from the group consisting of 0, 0.1, 0.2, 0.3, 0.4, 0.5, 0.6, 0.7, 0.8, 0.9, and 1.0.

In some embodiments, the pyrochlore is a compound according to Formula II:

A₂B₂O_{7-z} (II),

wherein A is selected from the group consisting of Pb, Y, La, Gd, Bi, Dy, Cd, and Ti; B is selected from the group consisting of Ru, Ir, Rh, Sn, Ti, Pt, Os, and Pd; and z is a value between 0 and 1.

In some embodiments, A is Pb.

In some embodiments, B is Ru.

In some embodiments, z is selected from the group consisting of 0, 0.1, 0.2, 0.3, 0.4, 0.5, 0.6, 0.7, 0.8, 0.9, and 1.0.

In some embodiments, the pyrochlore is Pb₂Ru₂O_{7-z}.

In some embodiments, the pyrochlore does not comprise Bi. In some embodiments, the pyrochlore is essentially free of Bi. In some embodiments, the pyrochlore being essentially free of Bi means that the pyrochlore comprises less than about 5% of Bi.

In some embodiments, the pyrochlore has a metal deposited thereon. In some embodiments, the metal is selected from the group consisting of Ru, Ir, Rh, Re, Sn, Ti, Pt, Os, Zr, and Pd.

In some embodiments, the cathode comprises a catalyst selected from the group consisting of Pt, Pd, alloys of Pt and alloys of Pd supported on C, RuO₂, Ni(OH)₂, TiO₂, SnO₂, TiO₂ with Nb or Ru dopants, SnO₂ with Sb or Ta dopants, and combinations thereof. Suitable alloys of Pd supported on C are described in U.S. Pat. No. 9,799,881, which is incorporated by reference herein.

In some embodiments, the cathode comprises a Pt/C catalyst. In some embodiments, the cathode comprises a Pt/RuO₂—TiO₂ catalyst. In some embodiments, the cathode comprises a Pt/C/Ni(OH)₂ catalyst.

In some embodiments, the electrolytical cell comprises an aqueous solution. In some embodiments, the aqueous solution is water.

As used herein, brine is a solution comprising water and relatively high concentrations of NaCl. In some embodiments, brine is a solution comprising water, relatively high concentrations of NaCl, and perchlorate salts. In some embodiments, brine is a solution comprising a salt comprising (i) at least one cation selected from the group consisting of lithium, sodium, potassium, barium, calcium, magnesium and ammonium; and (ii) at least one anion selected from the group consisting of chloride, perchlorate, sulfate, carbonate, bicarbonate and nitrate.

In some embodiments, the brine is brackish water. In some embodiments, the brine has a NaCl concentration in the range of from about 0.05% to about 3%, from about 0.10% to about 2%, or from about 0.15% to about 1%.

In some embodiments, the brine is saline water. In some embodiments, the brine has a NaCl concentration in the range of from about 3% to about 5%.

In some embodiments, the brine is seawater. In some embodiments, the brine has a NaCl concentration of about 3.5%.

In some embodiments, the brine is a saturated brine. In some embodiments, the brine has a NaCl concentration in the range of from about 5% to about 28%, from about 10% to about 25%, or from about 15% to about 20%. In some embodiments, the brine has a NaCl concentration greater than about 28%.

In some embodiments, the brine solution comprises a perchlorate salt. The perchlorate salt improves the electrolyte conductivity without blocking the catalytic reaction sites, thereby improving cell performance.

In some embodiments, the brine solution comprises a perchlorate salt in a concentration in the range of from about 0.1M to about 3M, from about 0.5M to about 2M, or from about 0.75M to about 1.5M.

In some embodiments, the electrolytic cell comprises a perchlorate salt selected from the group consisting of Mg(ClO₄)₂, Ca(ClO₄)₂, NaClO₄, salts of Li, Ba, K, and Mg, and combinations thereof.

In some embodiments, the brine solution comprises CO₂. In some embodiments, the CO₂ is added to the brine solution. In some embodiments, the brine solution comprises CO₂ that is added to a natural brine solution. In some embodiments, the brine solution naturally comprises CO₂. Brine solutions that naturally include CO₂ may include CO₂ dissolved from the atmosphere. In some embodiments, the brine solution comprises CO₂ at a concentration in the range of from about 0.0001M to about 3M.

In some embodiments, the brine solution has a neutral pH or a near neutral pH.

In some embodiments, the brine solution has a pH in the range of from about 7 to about 8.

In some embodiments, the ion exchange membrane is selected from the group consisting of an anion exchange membrane and a proton exchange membrane. In some embodiments, the ion exchange membrane is an anion exchange membrane. In some embodiments, the ion exchange membrane is selected from the group consisting of block copolymers, SEBS membranes, QPEK membranes, and combinations thereof.

In some embodiments, any suitable anion exchange membrane known in the art is used. Suitable anion exchange membranes include those described in US20190044158 and WO2020028374, which are incorporated by reference herein.

Also described herein is a method of using an electrolytic cell, wherein the electrolytic cell comprises a cathode, an anode comprising a pyrochlore comprising a metal deposited thereon, and an ion exchange membrane separating the cathode and the anode. The method comprises using the electrolytic cell as an electrolyzer and/or a fuel cell.

Also described herein is a method of using an electrolytic cell, wherein the electrolytic cell comprises a cathode, an anode comprising a pyrochlore comprising a metal deposited thereon, an ion exchange membrane separating the cathode and the anode, and a brine solution in contact with the anode and the cathode. The brine solution optionally comprises a perchlorate salt. The method comprises using the electrolytic cell to produce H₂ and O₂ from the brine solution.

In some embodiments, the method step of using the electrolytic cell to produce H₂ and O₂ from the brine solution comprises applying a current having a current density in the range of from about 500 mA/cm² to about 1500 mA/cm². In some embodiments, the method step of using the electrolytic cell to produce H₂ and O₂ from the brine solution comprises applying a current having a current density less than about 1000 mA/cm². In some embodiments, the method step of using the electrolytic cell to produce H₂ and O₂ from the brine solution comprises applying a current having a current density greater than about 1000 mA/cm² at below 2V cell voltage.

In some embodiments, the method step of using the electrolytic cell to produce H₂ and O₂ from the brine solution comprises using the electrolytic cell at a temperature in the range of from about −70° C. to about 40° C. In some embodiments, the method step of using the electrolytic cell to produce H₂ and O₂ from the brine solution comprises using the electrolytic cell at a temperature in the range of from about −70° C. to about 25° C. In some embodiments, the method step of using the electrolytic cell to produce H₂ and O₂ from the brine solution comprises using the electrolytic cell at a temperature in the range of from about −70° C. to about 0° C. In some embodiments, the method step of using the electrolytic cell to produce H₂ and O₂ from the brine solution comprises using the electrolytic cell at a temperature in the range of from about −70° C. to about −5° C. In some embodiments, the method step of using the electrolytic cell to produce H₂ and O₂ from the brine solution comprises using the electrolytic cell at a temperature in the range of from about −70° C. to about −20° C. In some embodiments, the method step of using the electrolytic cell to produce H₂ and O₂ from the brine solution comprises using the electrolytic cell at a temperature less than about −5° C.

In some embodiments, the method step of using the electrolytic cell to produce H₂ and O₂ from the brine solution comprises using the electrolytic cell at a temperature in the range of from about −5° C. to about 40° C. In some embodiments, the method step of using the electrolytic cell to produce H₂ and O₂ from the brine solution comprises using the electrolytic cell at a temperature in the range of from about 0° C. to about 40° C. In some embodiments, the method step of using the electrolytic cell to produce H₂ and O₂ from the brine solution comprises using the electrolytic cell at a temperature in the range of from about −5° C. to about 25° C.

In some embodiments, the H₂ and O₂ are concurrently produced. In some embodiments, the H₂ and O₂ are concurrently produced and are essentially free of Cl₂. In some embodiments, the H₂ and O₂ being concurrently produced and being essentially free of Cl₂ means that Cl₂ is produced in an amount less than about 10%, less than about 5%, less than about 3%, less than about 1%, less than about 0.5% or less than about 0.1% of the total products. In some embodiments, the H₂ and O₂ are concurrently produced and are essentially free of CO. In some embodiments, the H₂ and O₂ being concurrently produced and being essentially free of CO means that CO is produced in an amount less than about 10%, less than about 5%, less than about 3%, less than about 1%, less than about 0.5% or less than about 0.1% of the total products.

In some embodiments, the perchlorate salt is added to the brine solution. In some embodiments, the brine solution comprises a perchlorate salt that is added to a natural brine solution. In some embodiments, the brine solution is a terrestrial brine solution. In some embodiments, the brine solution is a seawater brine solution.

In some embodiments, the brine solution naturally comprises a perchlorate salt.

In some embodiments, the brine solution is an extraterrestrial liquid water brine solution. In some embodiments, the brine solution is a Martian liquid water brine solution.

In some embodiments, the brine solution is a mixture of a terrestrial brine solution and an extraterrestrial liquid water brine solution.

Further aspects of the present disclosure are provided by the subject matter of the following clauses:

1. An electrolytic cell comprising:

a cathode;

an anode comprising a pyrochlore;

an ion exchange membrane separating the cathode and the anode; and

a brine solution in contact with the anode and the cathode, wherein the brine solution optionally comprises a perchlorate salt.

2. The electrolytic cell of the preceding clause, wherein the brine solution comprises NaCl in a concentration in a range of from about 0.05% to about 3%.

3. The electrolytic cell of any preceding clause, wherein the brine solution comprises NaCl in a concentration in a range of from about 3% to about 5%.

4. The electrolytic cell of any preceding clause, wherein the brine solution comprises NaCl in a concentration in a range of from about 5% to about 28%.

5. The electrolytic cell of any preceding clause, wherein the brine solution does not comprise a perchlorate salt.

6. The electrolytic cell of any preceding clause, wherein the brine solution comprises a perchlorate salt selected from the group consisting of Mg(ClO₄)₂, Ca(ClO₄)₂, NaClO₄, salts of Li, Ba, K, and Mg, and combinations thereof.

7. The electrolytic cell of any preceding clause, wherein the brine solution comprises a perchlorate salt in a concentration in the range of from about 0.1M to about 3M.

8. The electrolytic cell of any preceding clause, wherein the pyrochlore is a compound according to Formula I:

A¹ₓA²₂₋ₓB¹_{y}B²_{2-y}O_{7-z} (I),

wherein

A¹ and A² are each independently selected from the group consisting of Pb, Y, La, Gd, Bi, Dy, Cd, Tl, and Ca;

B¹ and B² are each independently selected from the group consisting of Ru, Ir, Rh, Re, Sn, Ti, Pt, Os, Zr, and Pd;

x is a value between 0 and 2;

y is a value between 0 and 2; and

z is a value between 0 and 1.

9. The electrolytic cell of any preceding clause, wherein the pyrochlore is essentially free of Bi.

10. The electrolytic cell of any preceding clause, wherein the cathode comprises a catalyst selected from the group consisting of Pt, Pd, alloys of Pt and alloys of Pd supported on C, RuO₂, Ni(OH)₂, TiO₂, SnO₂, TiO₂ with Nb or Ru dopants, SnO₂ with Sb or Ta dopants, and combinations thereof.

11. The electrolytic cell of any preceding clause, wherein the ion exchange membrane is selected from the group consisting of an anion exchange membrane and a proton exchange membrane.

12. A method of using an electrolytic cell, the method comprising:

using the electrolytic cell to produce H₂ and O₂ from a brine solution;
wherein the electrolytic cell comprises:
   a cathode;
   an anode comprising a pyrochlore;
   an ion exchange membrane separating the cathode and the anode; and
   a brine solution in contact with the anode and the cathode, wherein the brine solution optionally comprises a perchlorate salt.

13. The method of the preceding clause, wherein the method step of using the electrolytic cell to produce H₂ and O₂ from the brine solution comprises applying a current having a current density in the range of from about 500 mA/cm² to about 1500 mA/cm².

14. The method of any preceding clause, wherein the method step of using the electrolytic cell to produce H₂ and O₂ from the brine solution comprises using the electrolytic cell at a temperature in the range of from about −70° C. to about 40° C.

15. The method of any preceding clause, wherein the H₂ and O₂ are concurrently produced.

16. The method of any preceding clause, wherein the brine solution does not comprise a perchlorate salt.

17. The electrolytic cell of any preceding clause, wherein the brine solution comprises NaCl.

18. The method of any preceding clause, wherein the brine solution comprises a perchlorate salt that is added to a natural brine solution.

19. The method of any preceding clause, wherein the brine solution naturally comprises a perchlorate salt.

20. The method of any preceding clause, wherein the pH of the brine solution is in the range of from about 7 to about 8.

21. An electrolytic cell comprising:

a cathode;

an anode comprising a pyrochlore comprising a metal deposited thereon; and

an ion exchange membrane separating the cathode and the anode.

22. The electrolytic cell of the preceding clause, wherein the electrolytic cell is a unitized regenerative fuel cell.

23. The electrolytic cell of any preceding clause, wherein the electrolytic cell is a fixed gas unitized regenerative fuel cell.

24. The electrolytic cell of any preceding clause, wherein the pyrochlore is a compound according to Formula I:

A¹ₓA²₂₋ₓB¹_{y}B²_{2-y}O_{7-z} (I),

wherein

A¹ and A² are each independently selected from the group consisting of Pb, Y, La, Gd, Bi, Dy, Cd, Tl, and Ca;

B¹ and B² are each independently selected from the group consisting of Ru, Ir, Rh, Re, Sn, Ti, Pt, Os, Zr, and Pd;

x is a value between 0 and 2;

y is a value between 0 and 2; and

z is a value between 0 and 1.

25. The electrolytic cell of any preceding clause, wherein the pyrochlore is essentially free of Bi.

26. The electrolytic cell of any preceding clause, wherein the metal is selected from the group consisting of Ru, Ir, Rh, Re, Sn, Ti, Pt, Os, Zr, and Pd.

27. The electrolytic cell of any preceding clause, wherein the cathode comprises a catalyst selected from the group consisting of Pt, Pd, alloys of Pt and alloys of Pd supported on C, RuO₂, Ni(OH)₂, TiO₂, SnO₂, TiO₂ with Nb or Ru dopants, SnO₂ with Sb or Ta dopants, and combinations thereof.

28. The electrolytic cell of any preceding clause, wherein the ion exchange membrane is selected from the group consisting of an anion exchange membrane and a proton exchange membrane.

29. An electrolyzer comprising the electrolytic cell of any preceding clause.

30. A fuel cell comprising the electrolytic cell of any preceding clause.

31. The fuel cell of the preceding clause, wherein the fuel cell is a fixed-gas unitized regenerative fuel cell.

32. A method of using an electrolytic cell, the method comprising:

using the electrolytic cell as an electrolyzer and/or a fuel cell;
wherein the electrolytic cell comprises:
   a cathode;
   an anode comprising a pyrochlore comprising a metal deposited thereon; and
   an ion exchange membrane separating the cathode and the anode.

33. The method of the preceding clause, wherein the method comprises using the electrolytic cell as an electrolyzer.

34. The method of any preceding clause, wherein the method comprises electrolyzing water.

35. The method of any preceding clause, wherein the method comprises electrolyzing brine.

36. The method of any preceding clause, wherein the method comprises using the electrolytic cell as a fuel cell.

37. The method of any preceding clause, wherein the method comprises supplying an oxidant and a fuel source to the electrolytic cell.

38. The method of any preceding clause, wherein the oxidant is O₂.

39. The method of any preceding clause, wherein the fuel source is H₂.

40. The method of any preceding clause, wherein the electrolytic cell is a fixed-gas unitized regenerative fuel cell.

### EXAMPLES

### Example 1. Brine Electrolyzer

Materials and Methods.

Synthesis of Lead Ruthenate Pyrochlores (Pb₂Ru₂O_{7-δ}).

5 mmol Ruthenium (III) nitrosylnitrate (Ru(NO)(NO₃)₃, Ru 31.3% minimum, Alfa Aesar) were dissolved in 25 mL of DI water (18.2 MΩ cm) and stirred for 10 minutes. 5 mmol lead (II) nitrate (Pb(NO₃)₂, 99.999%, Sigma Aldrich) was also separately dissolved in 25 mL DI water and stirred for 10 minutes. The solutions were mixed and stirred for an additional 30 minutes. Subsequently, the mixture was added to 500 mL 4 M KOH solution and a precipitate was obtained. The precipitate was crystallized by maintaining the KOH solution at 85° C. with continuous oxygen bubbling for 5 days. The solution volume was maintained by adding DI water every 24 hours. Following 5 days of crystallization, the solid was separated by centrifugation (Thermo Scientific, Heraeus Multifuge X1) at 10000 rpm, with a subsequent centrifugal wash with DI water until pH 7-8 was achieved. Upon reducing the pH, the solid was further washed 3 times with glacial acetic acid followed by acetone (3 times) and dried at 60° C. overnight in an oven. The dry solid was ground and used for experiments.

Analytical Characterization of Lead Ruthenate Pyrochlores (Pb₂Ru₂O_{7-δ}).

The electrical conductivity of Pb₂Ru₂O_{7-δ} was measured using a custom two-electrode conductivity cell consisting of two Cu solid rods encased in a hollow polyether ether ketone (PEEK) block. The powdered samples were placed between the Cu rods and compressed at a constant torque of 0.29 kg-m to ensure good electrical contact. The resistance (Q, ohm) was calculated using electrochemical impedance spectroscopy (EIS) with a frequency range of 0.1-105 Hz with amplitude of 10 mV. The conductivity was measured according to the following formula:

σ=l/R×A (Eq. 1),

where, σ is conductivity (S cm⁻¹), l is the sample thickness (cm), R is the measured resistance (ohm) and A is the cross-sectional area (cm²).

The morphology of the samples and their elemental composition was examined using scanning electron microscopy (SEM) coupled with energy dispersive analysis of X-rays (EDAX) using a JEOL JSM-7001 LVF Field Emission SEM. Crystallographic characterization using X-ray diffraction (XRD) was carried out with a Bruker d8 advance x-ray diffractometer, scanning from 20 to 800 (2θ) at a rate of 0.5° minute⁻¹ followed by Rietveld refinement to determine the lattice constant. X-ray photoelectron spectroscopy (XPS) was performed on Pb₂Ru₂O_{7-δ} using 5000 VersaProbe II Scanning ESCA Microprobe with Al K-alpha x-ray source to determine the surface elemental composition and oxidation states. N₂ adsorption-desorption isotherms obtained using a QuantaChrome (QuantaSorb) instrument were analyzed using the Brunauer-Emmett-Teller (BET) model to determine the catalyst specific surface area.

Experimental Simulation of Martian Environment.

The Martian regolith composition has been determined to have substantial concentrations of perchlorate salts. This composition is shown below in Table 1.

TABLE 1
Martian regolith composition as determined from
surface samples from the Phoenix lander.

| Ion | Measured concentration (moles × 10⁻⁵/cm³) |
|---|---|
| Na⁺ | 3.23 |
| K⁺ | 0.74 |
| Ca²⁺ | 1.28 |
| Mg²⁺ | 7.31 |
| Cl⁻ | 0.97 |
| ClO₄⁻ | 5.83 |
| SO₄²⁻ | 13.4 |

All experiments were performed in a simulated Martian environment. The low Martian terrestrial temperatures (−36° C.) were maintained by immersing the entire electrochemical experimental setup in a dry-ice bath with an ethylene glycol and ethanol mixture. By controlling the ratio of ethanol and ethylene glycol the temperature was lowered to −36° C. The CO₂-rich Martian atmosphere was simulated by purging CO₂ into the electrolyte. All measurements were carried out in a 2.8 M Mg(ClO₄)₂ solution to mimic the anticipated liquid brine solutions on the Martian surface. Despite the low atmosphere pressure in Mars, the regolithic brines remained in the liquid phase.

Electrochemical Measurements of Lead Ruthenate Pyrochlores (Pb₂Ru₂O_{7-δ}).

The ORR and OER electrochemical activities of Pb₂Ru₂O_{7-δ} at various reaction regimes were evaluated using the standard rotating disk electrode (RDE) method. Catalyst inks were prepared by ultrasonication (QSonica; Q700 sonicator) of a mixture of 25 mg catalyst, 6 mL of 24% (vol/vol) isopropanol/water, 0.275 mL of Nafion solution (Sigma Aldrich; 5 wt % solution in aliphatic alcohols) and 0.250 mL of 1 M KOH for 10 minutes (1 minute of sonication followed by 30 seconds cool down). KOH was added to neutralize the acidity of Nafion to preclude the possibility of Pb₂Ru₂O_{7-δ} exposure to acidic environments.

Electrochemical measurements were carried out using a conventional three-electrode setup (Pine instruments, AKCELL). The working electrode (WE) consisted of a thin-film of 200 μg cm⁻²_{disk} of Pb₂Ru₂O_{7-δ} supported on glassy carbon (GC). The WE was prepared by drop casting 10 μL of the Pb₂Ru₂O_{7-δ} ink onto a 0.196 cm² GC electrode polished to a mirror-like finish using 0.05 μm alumina slurry (Pine Instruments). The ink was dried in an uniform manner with homogenous particle distribution by rotating the RDE rotor at 400 rpm in an inverted position. Pt mesh and Ag wire were used as the counter and pseudo-reference electrode respectively. Linear sweep voltammetry (LSV) was recorded by sweeping the potential at 20 mV s⁻¹ in N₂—, O₂— and CO₂-saturated 2.8 M Mg(ClO₄)₂ electrolyte at different temperatures. The non-faradaic, capacitive current contributions were obtained from the scans under a N₂ atmosphere.

Solution resistance was measured as 10Ω using EIS. Cathodic and anodic potential scans were carried out to measure the ORR and OER currents. All the LSV scans were corrected for resistive and capacitive contributions. The measurements were carried out at different temperatures between 21° C. to −36° C. The OER measurements were carried out under both O₂ and CO₂ atmospheres while ORR was carried out only with O₂-saturated electrolyte.

Simulated Martian regolithic brine electrolyzer.

The Pb₂Ru₂O_{7-δ} OER electrocatalyst was integrated into a 5 cm² single cell (Fuel Cell Technologies Inc.) solid-state alkaline water electrolyzer fed with CO₂ purged 2.8 M Mg(ClO₄)₂ operated at average Earth (21° C.) and Martian terrestrial temperatures (−36° C.). The anode bipolar plate was a corrosion-resistant titanium metal plate (2×2 mm² single parallel flow channels) to avoid carbon corrosion whereas cathode was a graphite plate (1×1 mm² three serpentine flow channels). A membrane electrode assembly (MEA) was fabricated by sandwiching an anion exchange membrane (AEM, Fumasep FAA-3-50, thickness=50 μm) between two gas diffusion electrodes (GDE). GDEs were prepared by painting catalyst ink with a N₂-propelled airbrush (Badger 150) on gas diffusion layers (GDLs) consisting of carbon paper with high wettability on the cathode side and titanium sheet on the anode side to avoid corrosion. For the anode, the Pb₂Ru₂O_{7-δ} ink was prepared by sonicating 0.05 g catalyst, 3.2 g isopropanol/water (1/1 vol %) and 0.176 g of 5 wt % solubilized AEM binder (Fumion FAA-3, Fumatech). For the cathode, the Pt/C catalyst (Pt 46.5%, Tanaka, Japan) ink was prepared by sonicating 0.05 g catalyst, 3.2 g isopropanol/water (1/1 vol %) and 0.428 g of 5 wt % solubilized AEM binder. This composition yields a catalyst to binder ratio of 85:15 and 70:30 for the anode and cathode, respectively. The Pb₂Ru₂O_{7-δ} loading was 1 mg cm⁻² on the anode side whereas Pt/C loading was maintained as 0.5 mg_{Pt} cm⁻² on the cathode side. The MEAs were ion-exchanged to the OH— form by immersing the AEM and electrodes in three batches of 1 M KOH each for 8-10 hours for a total of 24-30 hours followed by a thorough DI water wash. After the electrolyzer was assembled, 2.8 M Mg(ClO₄)₂ purged with CO₂ was fed to the electrolyzer at room temperature and Martian temperature (−36° C.) with a flow rate of 200 mL min⁻¹. A potential stair-step protocol was applied with the anodic sweep from 1.2 V to 2.2 V and the data was recorded following current relaxation after a 1 minute potentiostatic hold.

Results and Discussion.

OER Activities.

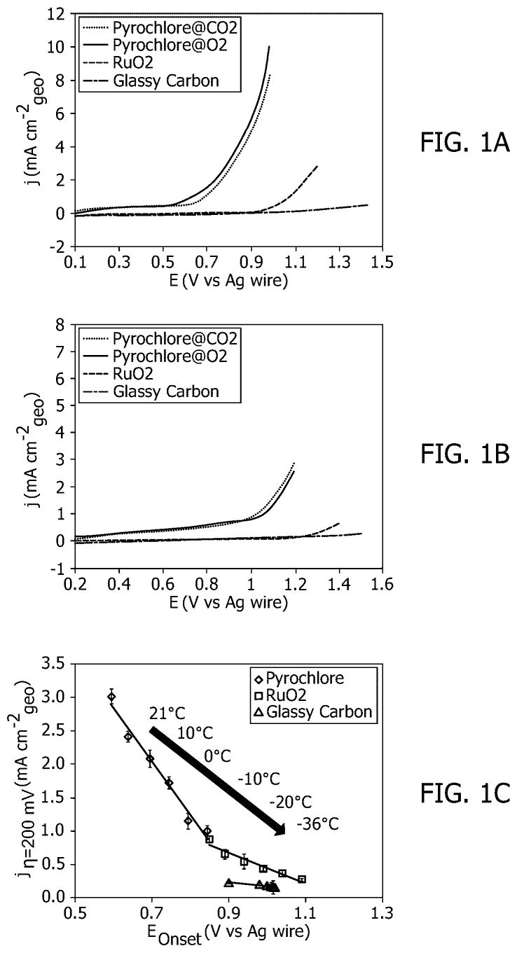

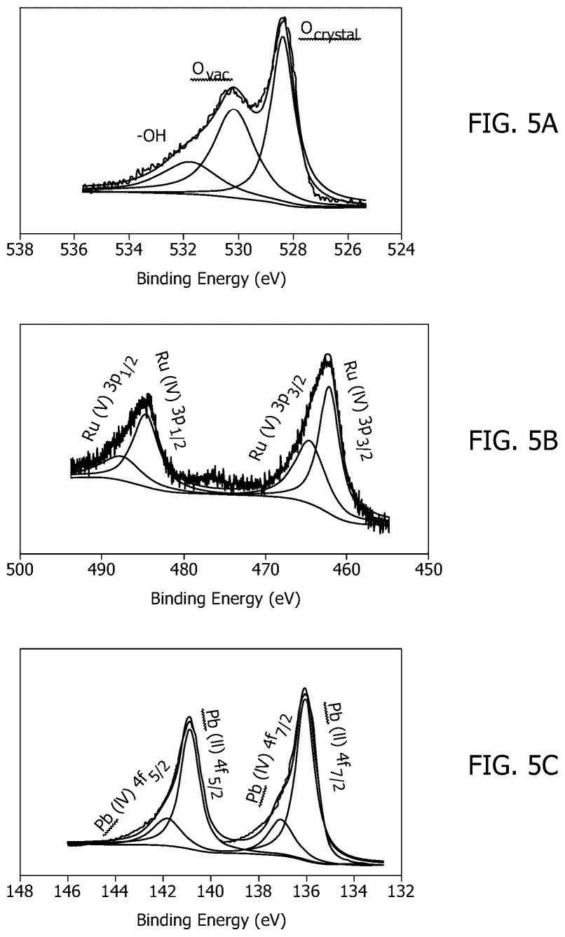

The OER activity of a synthesized Pb₂Ru₂O_{7-δ} pyrochlore electrocatalyst was examined in the SMRB and contrasted with a RuO₂ benchmark electrocatalyst. Linear sweep voltammograms (LSVs) that were obtained using a thin film rotating disk electrode (RDE) for different catalysts at 21° C. and −36° C. are depicted in FIGS. 1A and 1B, respectively. Initial measurements carried out in O₂-saturated SMRB showed minimal faradaic contributions from the base, glassy carbon (GC) electrode with a small increase in the current at potentials over 1.3V vs. Ag wire. RuO₂ exhibited OER activity at potentials over 0.9V vs. Ag wire whereas Pb₂Ru₂O_{7-δ} was OER-active even at 0.1V vs. Ag wire. The results confirmed significantly more facile OER kinetics of Pb₂Ru₂O_{7-δ} when compared to RuO₂ and GC in SMRB. The improved OER activity on Pb₂Ru₂O_{7-δ} is a function of the surface oxygen vacancies on this electrocatalyst. XPS data for this electrocatalyst are shown in FIGS. 5A-5C.

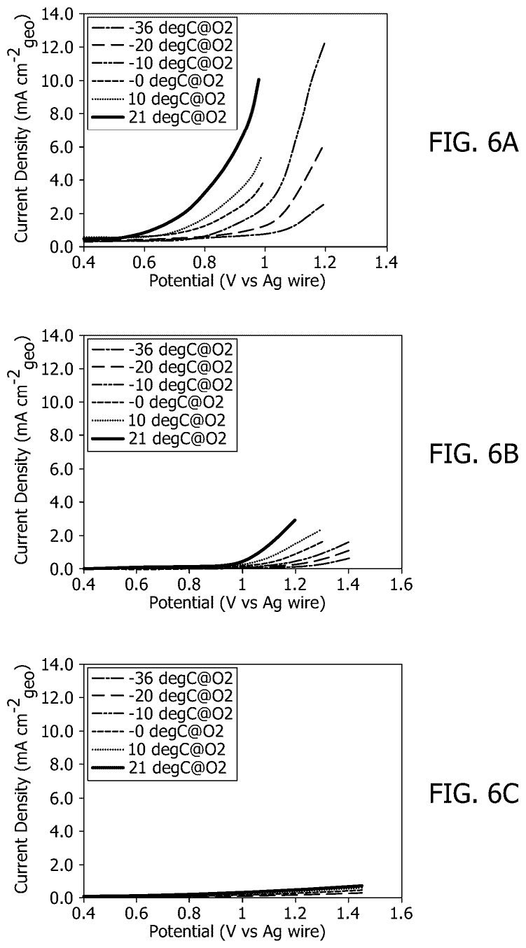

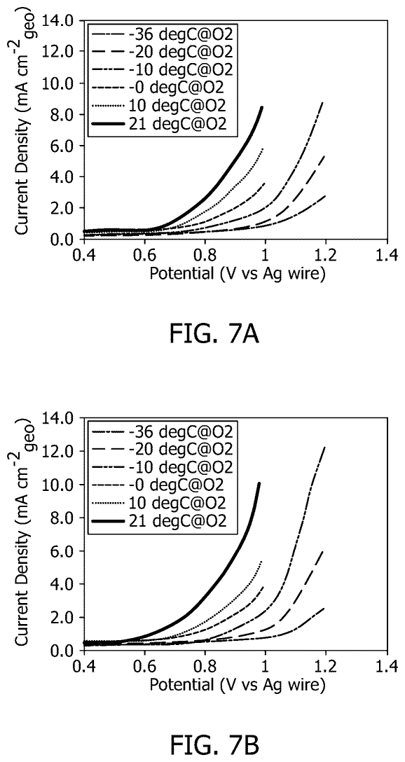

The OER activities for all the electrodes were also compared upon application of a constant overpotential (200 mV) as depicted in FIG. 1C and the relative activity trends were seen to hold across a wide range of temperature from 21° C. to −36° C. (the corresponding LSVs are depicted in FIGS. 6A-6C and FIGS. 7A-7B). Having established the superior OER activity of Pb₂Ru₂O_{7-δ} in an O₂-saturated SMRB, the OER activity was examined in a CO₂-saturated SMRB more representative of conditions on Mars. The activity and the overpotential were largely unaffected by the shift from O₂ to CO₂ saturated SMRB (within experimental error) as seen in FIGS. 1A and 1B.

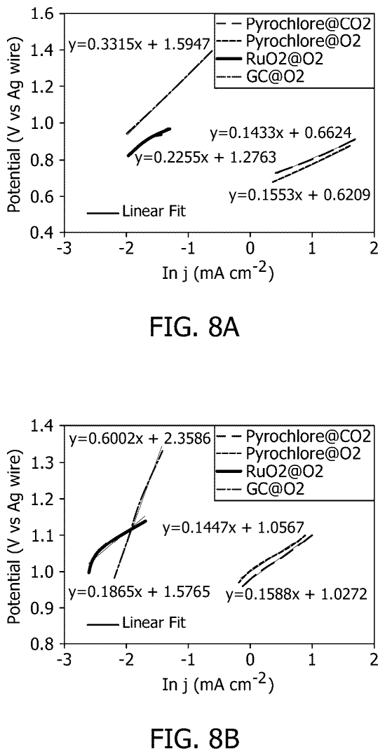

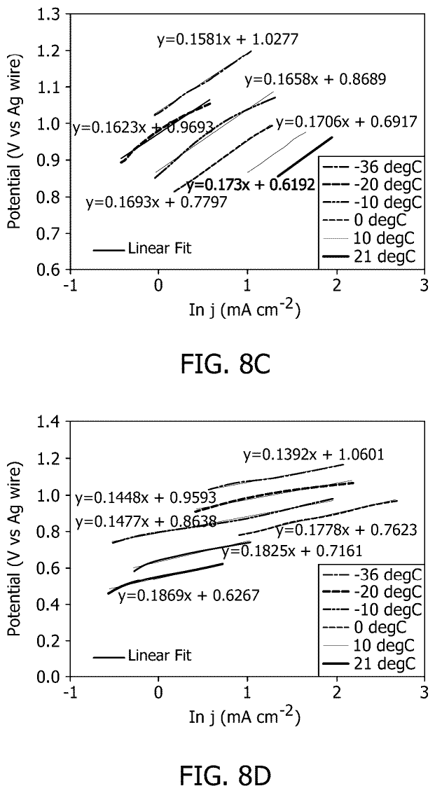

Pb₂Ru₂O_{7-δ} was also tested across a range of temperatures in CO₂-saturated SMRB (FIGS. 7A-7B), exhibiting a similar trend as that seen in O₂-saturated SMRB. Pb₂Ru₂O_{7-δ} was found to exhibit greater bifunctional ORR (oxygen reduction reaction)/OER activity as compared to RuO₂ in near-neutral media by applying the Marcus-Hush kinetic formulation to the Tafel analysis of the LSVs. Tafel slopes are shown in FIGS. 8A-8D. This provides a pathway for the utilization of the H₂ produced by the electrolyzer in a fuel cell with a Pb₂Ru₂O_{7-δ} cathode and for the eventual development of a unitized regenerative fuel cell (URFC) for use in Mars-like conditions.

Reaction Conditions.

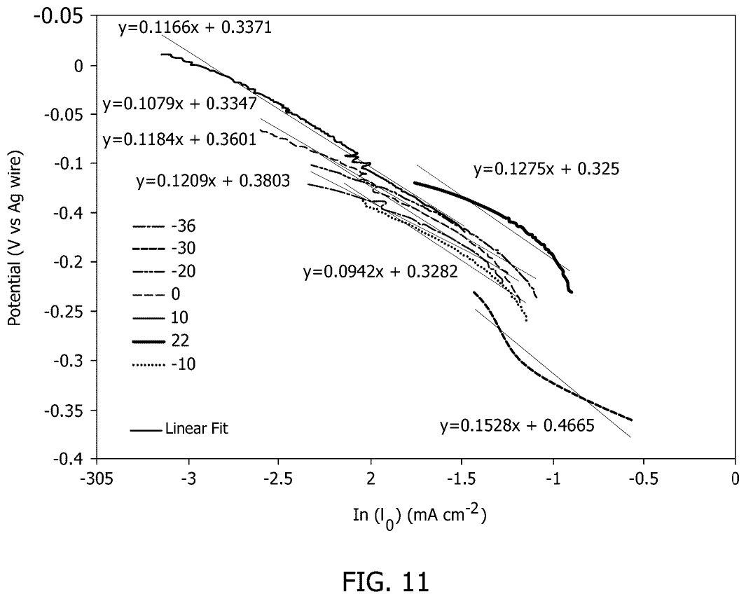

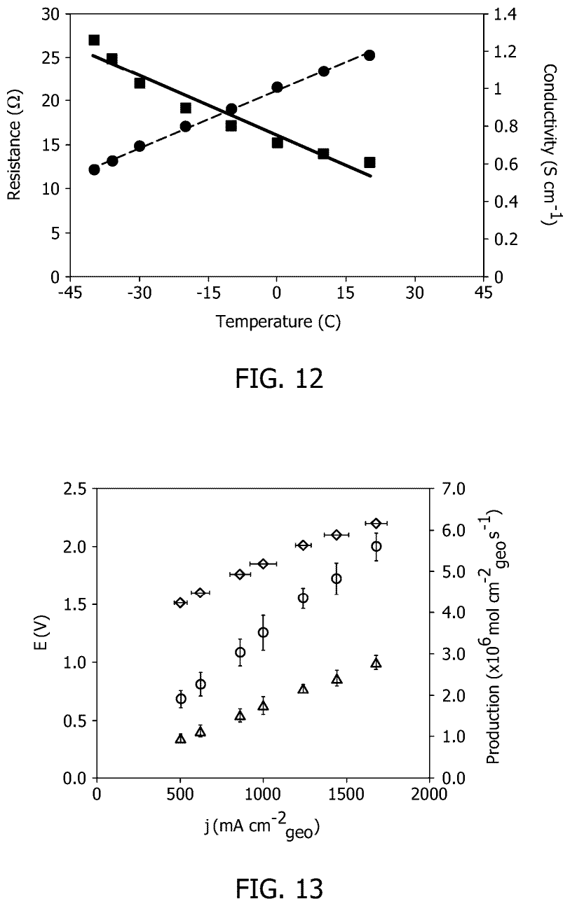

To identify the limiting reaction in the SMRB electrolyzer, the hydrogen evolution reaction (HER) was examined on Pt/C in CO₂-saturated SMRB over a range of temperatures from 21° C. and −36° C. (FIG. 11). Given that the ratio of overpotential to current density (i.e. the Tafel slope) is lower for the ORR (94-152 mV/dec) at all the temperatures compared to the OER (158-173 mV/dec) on Pb₂Ru₂O_{7-δ} under the same conditions (FIG. 8C), it is apparent that the oxygen electrode is the limiting electrode. The ionic conductivity of the electrolyte was also found to exhibit a linear relationship (decrease) with temperature over the entire range from 21° C. to −36° C. (FIG. 12). The effect of change in solution conductivity on OER and ORR activity was considered during the calculation (iR drop correction).

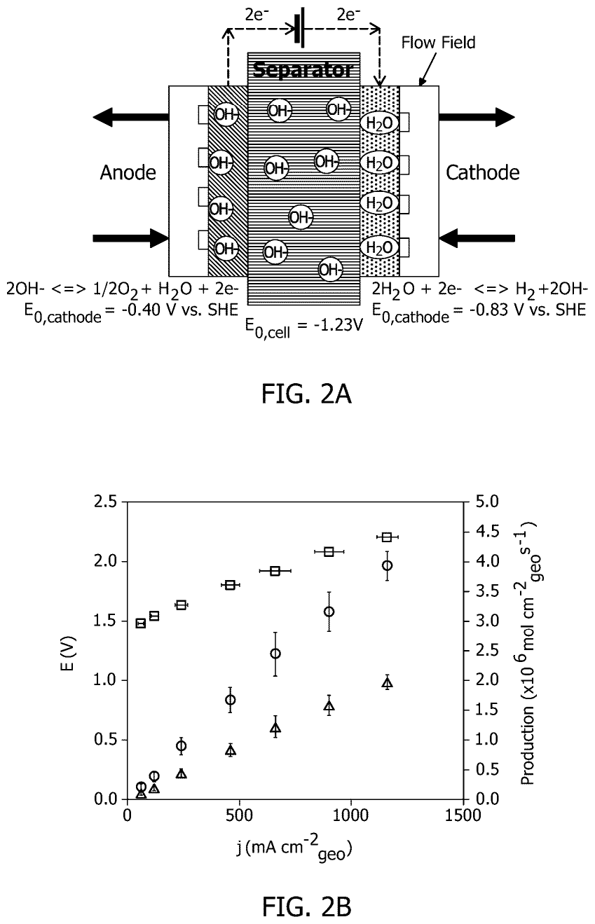

Electrolyzers built with Pb₂Ru₂O_{7-δ} anodes, a commercial Fumasep FAA-3-50 anion-exchange membrane (AEM) separators, and Pt/C cathodes (FIG. 2A) were operated with a 200 mL min⁻¹ CO₂ saturated SMRB feed to both the anode and cathode to mitigate water transport/membrane drying issues. Anticipated CO₂ poisoning of the AEMs was mitigated by regenerating the AEM using potentiostatic holds at higher potentials. Following an initial 30-minute potentiostatic hold at 2.5 V, the electrolyzer was polarized in steps between 1.4 V-2.2 V and allowed to relax to a steady electrolyzing current. The resultant polarization (j-E) performance was recorded and the corresponding O₂ and H₂ production rates are shown (j-E curve at 21° C. in FIG. 13 and −36° C. in FIG. 2B). For the test in simulated Martian conditions, the feed was constantly purged with CO₂ and the electrolyzer temperature was maintained at −36° C. by employing a carefully calibrated bath of dry-ice with an ethylene glycol and ethanol mixture.

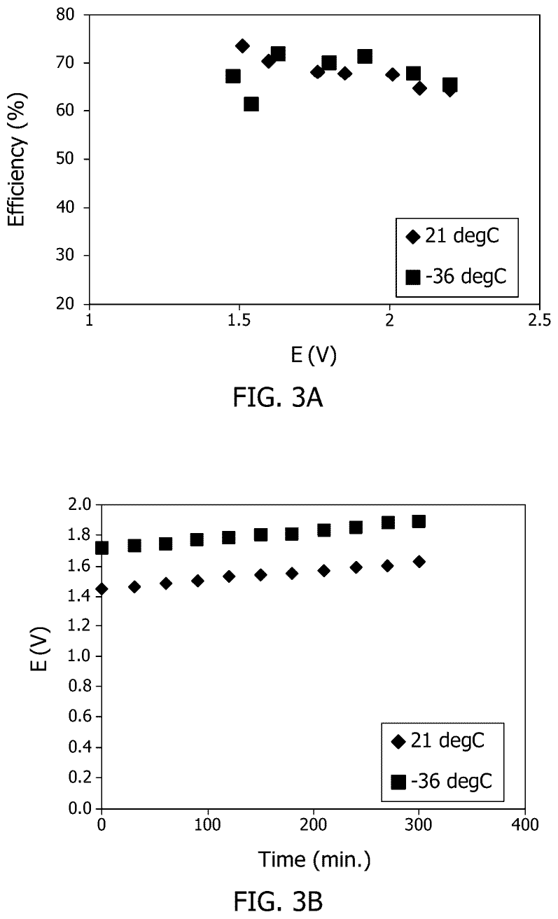

At both temperatures, the electrolyzer showed excellent performance with peak power densities of 1.23 W·cm⁻² (1.92 V, −36° C.) and 1.85 W·cm⁻² (1.85 V, 21° C.), with the decrease in performance in direct correlation to the device temperature being attributed to a combination of lower faradaic currents due to lower reaction rates and increased device resistance due to sluggish ion transport. To put the performance in perspective, reported solid-state alkaline water electrolyzers operating at 50° C. with a Pb₂Ru₂O_{7-δ} anode achieved a power density of 1.2 W·cm⁻² at 1.85 V using a DI water feed. The electrolyzer was found to exhibit a faradaic efficiency of about 70% (FIG. 3A) and was found to experience about a 200 mV increase in voltage during a 300-minute constant current hold at 400 mA cm⁻² (FIG. 3B). Previous investigations have attributed similar increases in the electrolyzer resistance to the possible degradation of the commercial AEM binder at the anode. Given the operating conditions on Mars, judicious material selection is of paramount importance for future operational deployment.

Comparison to MOXIE.

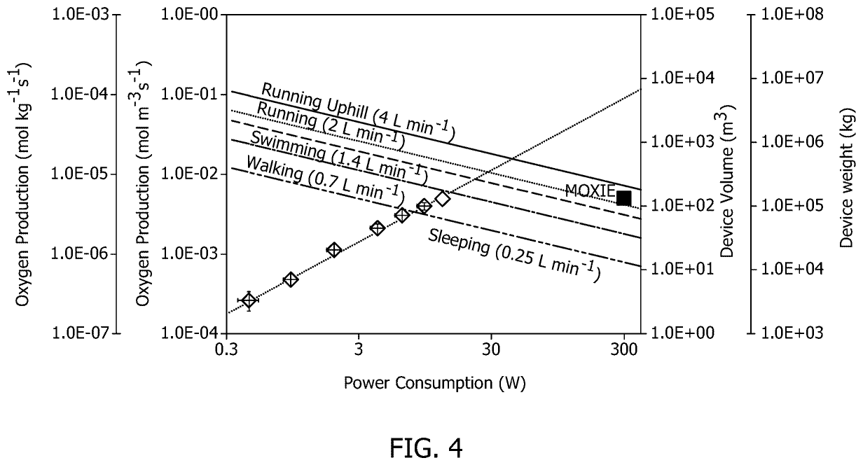

The metrics of the SMRB electrolyzer described herein were compared to existing plans for the generation of O₂ on Mars. MOXIE, developed by MIT and NASA as a test bed on the Mars 2020 mission, has been designed to produce 10-22 g. hr⁻¹ of O₂ by the electrolysis of CO₂. Utilizing the abundant CO₂ present in the Martian atmosphere, MOXIE produces O₂ and CO, with pure O₂ obtained by subsequent purification. Despite utilizing an abundant and geographically unconstrained feedstock, the production of CO represents a toxic inhalation hazard. Due to the differing design philosophies, the performances of electrolyzers in accordance with the present disclosure have been compared with MOXIE purely on the basis of the rate of O₂ production (FIG. 4). Further, the device weight and volume requirements to achieve a given O₂ production rate at rated operating power consumption have been examined FIG. 4). The values of O₂ consumption for various human activities at sea level on Earth was obtained from the US Navy Dive manual. To match MOXIE's O₂ production rate (10-22 g. hr⁻¹), an electrolyzer in accordance with the present disclosure needs to operate at a cell potential of 2.2 V with an electrode area of 28-62 cm². A healthy human being requires around 90 L_{O2}·hr⁻¹ and 300 L_{O2}·hr⁻¹ while resting and exercising heavily, respectively. Operating the present electrolyzer at 2.2 V, the cell active area required to satisfy these requirements is 375 cm² and 1235 cm², respectively. The present system produces more than 25 times the O₂ as MOXIE while consuming the same amount of power (FIG. 4). Extrapolating to the required production rates for various human activities, this electrolyzer will be smaller in both weight and volume compared to the current state-of-the-art MOXIE O₂-generator (FIG. 4). Based on these results, electrolyzers in accordance with the present disclosure will enable concurrent fuel and oxygen production at viable rates from Martian regolithic brines.

Analysis.

Analytical Characterization.

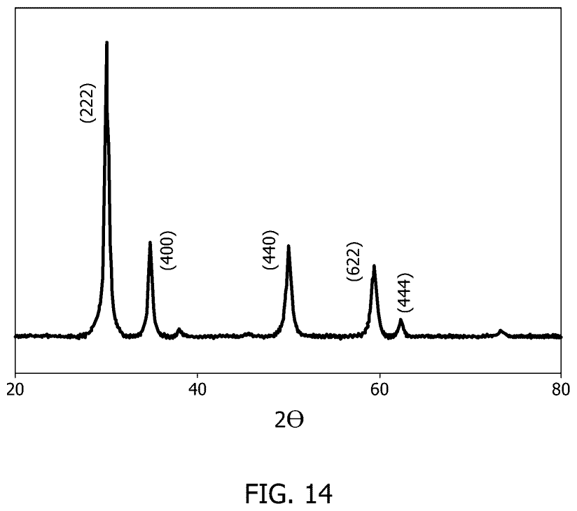

XRD on freshly prepared samples confirmed the presence of Pb—Ru pyrochlore phases (FIG. 14) when compared to the characteristic peaks of Pb₂Ru₂O_{7-δ} phases (JCPDS-ICDD=PDF-00-002-1365). The absence of additional peaks indicated the presence of high purity pyrochlore phases without any mixed oxide phases. Rietveld refinement yielded lattice constants of a=b=c=10.325 Å in agreement with prior reports. The manifestly high crystallinity of the sample, attributable to extensive O₂-purging (5 days) at 85° C. obviated the need for further annealing.

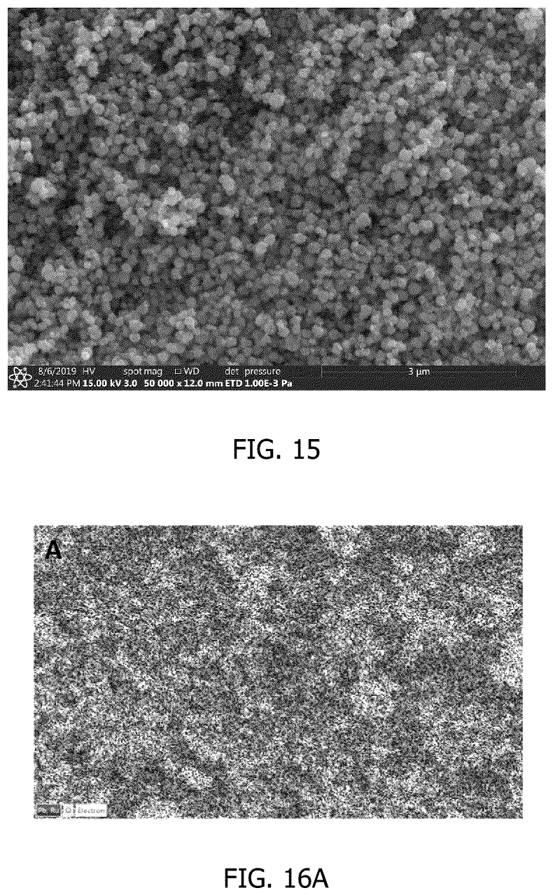

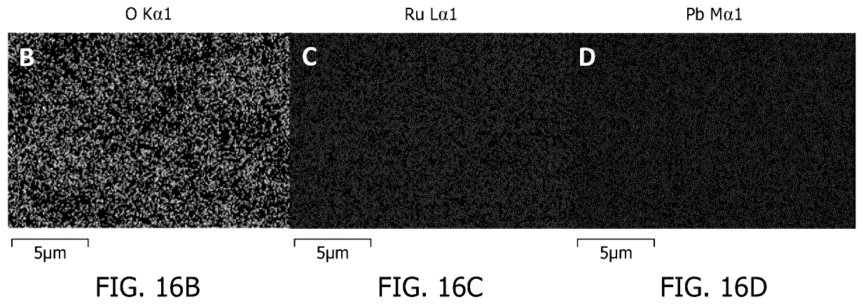

FIG. 15 depicts SEM micrographs indicating the formation of 70-140 nm spherical Pb₂Ru₂O_{7-δ} particles. The formation of Pb—Ru—O system and the composition were confirmed by EDAX mapping (FIGS. 16A-16D). XPS of the samples detected the presence of multiple oxidation states of Pb, Ru, and O in Pb₂Ru₂O_{7-δ}. The deconvolution of O 1s spectrum yielded three distinct peaks at about 528.3±0.2 eV, about 530±0.1 eV, and about 531±0.5 eV corresponding to O-atoms in crystal lattice, auxiliary oxidation state of O-atom due to creation of oxygen vacancy and surface —OH state of O-atoms, respectively (FIG. 5A). The deconvoluted Ru 3p XPS spectrum showed the presence of two different oxidation states of Ru:Ru (IV) 3p_{3/2}, Ru (V) 3p_{3/2}, Ru (IV) 3p_{1/2} and Ru (V) 3p_{1/2} at about 462.5±0.4 eV, about 464.5±0.4 eV, about 484.3±0.2 eV and about 486.6±0.3 eV, respectively (FIG. 5B). Deconvolution of Pb 4f XPS peak shows the presence of Pb (II) 4f_{7/2}, Pb (IV) 4f_{7/2}, Pb (II) 4f_{5/2} and Pb (IV) 4f_{5/2} at 136.2±0.2 eV, 137.3±0.3 eV, 141.3±0.1 eV and 142.2±0.2 eV, respectively (FIG. 5C). BET surface area of the Pb₂Ru₂O_{7-δ} sample has been found to be 90±4 m²/g. The conductivity of Pb₂Ru₂O_{7-δ} sample has been calculated as 82±4 S/cm.

The Thermodynamics of Martian Regolithic Brines.

The low Martian atmospheric pressure, of about 6.4 mbar depresses the boiling point of pure water to −39.9° C. This effect is countered in highly concentrated Mg(ClO₄)₂ brines where the high salt concentration elevates the boiling point. The boiling-point elevation is calculated via the following equation:

ΔT_{b}=K_{b}b_{B} (Eq. 2),

where, ΔT_{b} is the elevation in boiling-point (T_{b}(solution)−T_{b(pure solvent)}), K_{b} is the ebullioscopic constant of pure solvent (0.512 for pure water), and b_{B} is molality of the solution. b_{B} is calculated as b_{B}=bₛₒₗᵤₜₑi. Where, bₛₒₗᵤₜₑ is the molarity of the solute and i is the van't Hoff factor which is about 3 for Mg(ClO₄)₂. Equation 2 predicts a ΔT_{b} of 4.3° C. for 2.8 M Mg(ClO₄)₂, resulting in a boiling point of −35.6° C. Therefore, the perchlorate brine will neither freeze via freezing point depression nor vaporize/boil (vapor pressure_{water@-40 degC.=}0.39 mbar<<6.38 mbar=Martian atmospheric pressure) via boiling point elevation, allowing for the presence of liquid water solutions on the Martian surface.

The simulation of terrestrial Martian temperature accounted for the large diurnal temperature range, low atmospheric pressure, and highly concentrated perchlorate brine. The low diurnal temperatures (−39° C. to −81° C.) suggested that water is most likely to be present in the solid/ice state. However, water present in highly concentrated perchlorate brines experiences a freezing point depression resulted in a freezing temperature below −60° C. Therefore, spatiotemporal conditions exist on Mars to allow for the presence of liquid brine solutions. The extreme hygroscopic nature of perchlorate salts will also result in the absorption of atmospheric moisture even when present in very low concentrations of up to 210 ppm.

Electrochemistry in Simulated Martian Environment.

The OER activity of Pb₂Ru₂O_{7-δ} in O₂-purged simulated Martian regolithic brine (SMRB) was measured over a range of temperatures (21° C. to −36° C.) and benchmarked against RuO₂ and GC. Pb₂Ru₂O_{7-δ} exhibited higher OER currents (and hence OER activity) over the entire OER potential window compared to RuO₂ and GC at any temperature (FIGS. 6A-6C). FIGS. 7A-7B depict the impact of the purged gases on the OER activity of Pb₂Ru₂O_{7-δ}. The OER activity was unchanged between O₂ and CO₂ purged environment but the CO₂ purged SMRB exhibited<100 mV increase in the onset potential confirming minimal effect of gas environment. E vs. log j (Tafel) plots exhibited lower slopes for Pb₂Ru₂O_{7-δ} (144-155 mV dec⁻¹), demonstrating lower overpotentials/facile kinetics for OER compared to RuO₂ (187-225 mVdec⁻¹) and GC (331-600 mVdec⁻¹) electrodes at 21 and −36° C. (FIGS. 8A and 8B). Tafel slopes

$$( given by b = - \frac{2.3 R T}{α F} )$$

close to 118 mV dec⁻¹ indicate that the first electron transfer step is rate determining which confirms oxygen vacancy sensitive OER and the transfer coefficient (a) is 0.5, rendering both the forward and backward reaction equally facile. The effect of the solvation shell on charge transfer at (or near) electrode surfaces has previously been demonstrated.

The increasing Tafel slopes as a function of the temperature indicate an asymmetry in the overpotentials needed for the OER and ORR as the ORR is solvation controlled whereas OER is solvation independent as the solvent itself is the reactant (FIGS. 8C and 8D). The Tafel slopes depicted in FIGS. 8A-8D are seen to be independent of the purge gas while the intercept varies in line with the onset potential from the LSVs. Temperature was found to have no influence on the mechanism as the Tafel slopes were unchanged with temperature. The expected drop in the reaction rate constant was evident in the decrease in the intercept and hence the exchange current density. The low Tafel slopes exhibited by Pb₂Ru₂O_{7-δ} indicate that a is closer to 0.5 and hence the energetics of the ORR and OER are facile, in line with the observations of bifunctional ORR/OER activity. The higher concentration of surface oxygen vacancies as well as higher oxidation states of surface Ru (Ru(IV) and Ru(V)) as confirmed by XPS (FIGS. 5A-5C) on Pb₂Ru₂O_{7-δ} as compared to RuO₂ (Ru(IV)) facilitate higher adsorption of water (S+H₂O→S—OH+H⁺+e⁻) to promote the first electron transfer, improving the OER activity analogous to Co₃O₄ electrocatalysts reported in the literature.

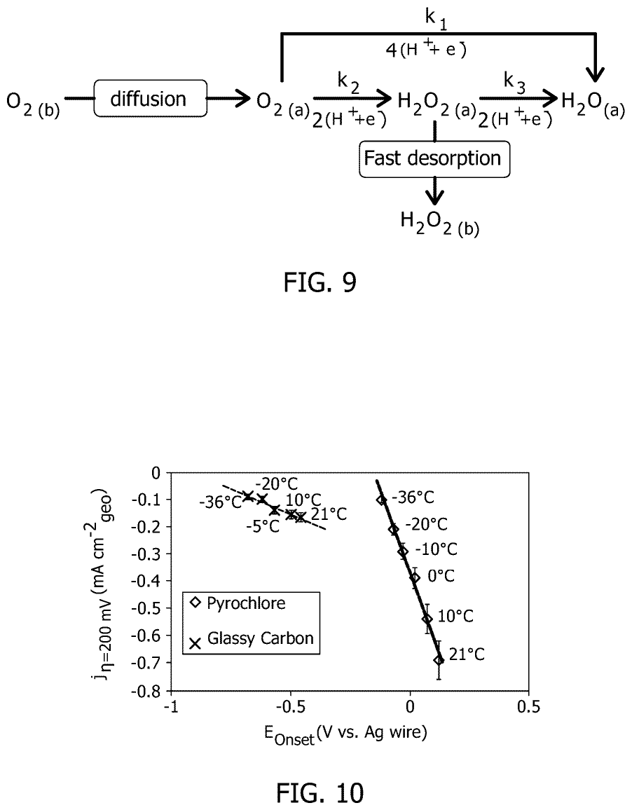

FIG. 9 depicts possible, non-limiting pathways for the reduction of O₂ in an acidic or near-neutral aqueous environment. The initial step in the ORR mechanism was considered to be the adsorption and subsequent reduction of oxygen to the superoxide radical. Outer sphere electron transfer to form O₂⁻ and the possible subsequent adsorption of the superoxide radical was also considered. The further electrochemical reduction of adsorbed O₂ (or O₂⁻) by protons is dependent on the adsorption orientation of the oxygen species with end-on, side-on, and bridge type adsorption being possibilities dictated by the nature of the electrode. Side-on adsorption is possible when the spacing between the catalytic active sites and the bond length of O₂ (or O₂⁻) are similar. Discussion regarding surface O₂ vacancies and the orientation renders an electrophilic H⁺ attack on either O atom equally likely and offers the best possibility to follow a direct 4-electron pathway to produce H₂O.

Alternatively, in end-on adsorption, the initial step is likely to be the formation of OOH species, followed by O—O bond cleavage and subsequent H⁺ attack to produce 20H′ which further reacts to produce 2H₂O.

Alternatively, the formation of OOH maybe followed by the addition of another H⁺ to produce H₂O₂. The H₂O₂ further reacts with a series of H⁺ ions to produce 2OH and then 2H₂O. The chemical decomposition of H₂O₂ to O₂ and the possible equilibriums in each of the steps in the mechanism are not considered due to the expected low concentration of H₂O₂ at the surface (due to constant convection during the rotation of the RDE) and the overpotential driving the reactions forward.

The ORR in the SMRB was examined at a range of temperatures to establish the activity of the Pb₂Ru₂O_{7-δ} electrocatalysts and then translate it to the simulated Martian conditions to produce energy on Mars in future. Given the wide range of temperatures examined and the consequent increase in the overpotential required to initiate ORR, the activity of the catalysts was examined at 200 mV overpotential at all temperatures, with the overpotential chosen to improve the faradaic efficiency of the overall unitized regenerative fuel cell (URFC=electrolyzer and fuel cell) system. In FIG. 10, the superior activity of Pb₂Ru₂O_{7-δ} compared to GC electrode is apparent at 21° C., with a 500 mV lower ORR onset potential and about three times the activity which is again attributed to high O₂ adsorption, subsequent dissociation facilitated by high oxygen vacancy content. Given that GC is poor catalyst for the 4-electron ORR to produce H₂O, it exhibits minimal activity loss when the system is cooled from 21° C. to −36° C. On the other hand, Pb₂Ru₂O_{7-δ} exhibit significant (˜⅓ times) activity loss over the same temperature range. However, despite the activity loss, the pyrochlore electrocatalyst still exhibits an onset potential that is about 500 mV lower than GC in a simulated Martian environment, providing a pathway to potential URFC development for energy and fuel production.

### Example 2. Regenerative Fuel Cell Including Pt-Pyrochlore as a Bifunctional Oxygen Electrocatalyst

Materials and Methods.

Synthesis of Lead Ruthenate Pyrochlores (Pb₂Ru₂O₇₋ₓ).

A 5 mmol ruthenium (III) nitrosylnitrate (Ru(NO)(NO₃)₃, Ru 31.3% minimum, Alfa Aesar) is dissolved in 25 mL of de-ionized (DI) water (18.2 MΩ cm) and stirred for 10 min which is added to a 25 mL solution containing 5 mmol lead (II) nitrate (Pb(NO₃)₂, 99.99%, Sigma Aldrich) in DI water. Then, the mixture is stirred for additional 30 min to achieve a homogeneous solution. The total 50 mL mixture is slowly added dropwise and precipitated in a 500 mL 4 M KOH solution in a plastic conical flask to avoid any corrosion of glass containers by the KOH solution. The precipitate is crystallized by maintaining the resultant solution at 85° C. with continuous oxygen bubbling for 5 days. The solution volume and concentration are maintained by adding DI water in every 24 h. After 5 days of crystallization, the resultant solid is separated from the solution by using centrifuge (Thermo Scientific, Heraeus Multifuge X1) at 10,000 rpm. Then, the separated solid is thoroughly washed with DI water using the centrifuge until a pH of 7-8 of the supernatants is achieved. After that, the material is washed three times with glacial acetic acid followed by acetone (three times) to remove any impurity. Finally, the solid is dried at 60° C. overnight in an oven, ground to powder and used for experiments.

Deposition of Platinum on Lead Ruthenate Pyrochlores (Pt—Pb₂Ru₂O₇₋ₓ).

0.45 g of chloroplatinic acid hexahydrate (H₂PtCl₆, 6H₂O) (Sigma Aldrich) is added to 180 mL of DI water under vigorous stirring. Then, 3.6 g of sodium bisulfite (NaHSO₃) is added into the solution under continuous stirring that turns the color of the solution from yellow (H₂PtCl₆) to colorless (H₃Pt(SO₃)₂OH). To dilute the solution, additional 450 mL of DI water is added which is followed by the dropwise addition of 0.6 M sodium carbonate (Na₂CO₃) buffer to the solution until pH=5 is reached. After that, 135 mL hydrogen peroxide (H₂O₂) is added dropwise together with 5 wt % NaOH. The addition of H₂O₂ decreases the solution pH rapidly. Therefore, initially H₂O₂ (2-3 mL) and NaOH are added slowly so that the solution pH is maintained at 5.0 to form the colloidal suspension of Pt-oxide (solution turns yellow). The reaction indicates near completion when the pH of the solution stops to decrease. Then, the rest of the H₂O₂ is added to complete the reaction. Finally, 0.56 g of Pb₂Ru₂O₇₋ₓ is added to the solution under stirring for 24 h to facilitate Pt-oxide adsorption onto Pb₂Ru₂O₇₋ₓ. The resultant black material is filtered and washed repeatedly by DI water. The washed black material is again dispersed in 100 mL DI water, stirred and followed by the addition of 100 mL absolute ethanol (1:1 vol/vol). Then, the solution is heated at 70° C. for 2 h with stirring to reduce Pt-oxide to Pt deposited on Pb₂Ru₂O₇₋ₓ. After the solution is cooled down, the particles are filtered, washed with DI water and dried overnight at 60° C. to achieve Pt—Pb₂Ru₂O₇₋ₓ.

Fabrication of MEA and URFC Operation.

The membrane electrode assembly (MEA) is prepared by sandwiching an anion exchange membrane (AEM, Fumasep FAA-3-50, thickness—50 μm) as separator between two gas diffusion electrodes (GDE). The GDEs are fabricated by spraying a catalyst ink with an airbrush (Badger 150) under N₂ flow on carbon paper and Ti-sheet (to avoid corrosion) for the cathode and anode, respectively. For the cathode side, the catalyst ink containing Pt/C catalyst (Pt 46.5%, Tanaka, Japan) is prepared by sonicating 0.05 g catalyst, 3.2 g methanol/water (1/1 vol %) and 0.428 g of 5 wt % solubilized AEM binder (Fumion FAA-3, Fumatech) to achieve a catalyst to binder ratio of 70:30. For the anode side, the catalyst ink containing Pt—Pb₂Ru₂O₇₋ₓ is prepared by sonicating 0.05 g catalyst, 3.2 g methanol/water (1/1 vol %) and 0.176 g of 5 wt % solubilized AEM binder to achieve a catalyst to binder ratio of 85:15. The Pt—Pb₂Ru₂O₇₋ₓ loading is achieved as 1 mg cm⁻² on the anode side whereas Pt/C loading is kept as 0.5 mg_{Pt} cm⁻² on the cathode side. As the AEMs are received in the bromide form, all the MEAs are ion-exchanged with OH⁻ by immersing them in three batches of 1 M KOH each for 8-10 hours for a total of 24-30 hours followed by a thorough DI water wash to remove any extra KOH.

The FG-URFC is operated by testing the MEA under both FC and WE mode. The WE is tested by the electrolysis of ultrapure DI water at 80° C. The DI water is heated using a hot plate/stirrer (Fisher Scientific), pumped only into the anode side and recirculated at a flow rate of 200 mL min⁻¹. Potential is swept anodically (stair-step protocol) from 1.25 V to 1.90 V and the current value is recorded after a 2 min potentiostatic-hold (OER on Pt—Pb₂Ru₂O₇₋ₓ anode and HER on Pt/C cathode). Before performing the fuel cell polarization experiments, the MEAs are conditioned by holding the cell at a constant voltage (potentiostatic-hold) of 0.55 V for 90 min to ensure stable operation. The fuel cell polarization data is obtained at 80° C. and 90% relative humidity (RH) using O₂ as oxidant (ORR on Pt—Pb₂Ru₂O₇₋ₓ anode) and H₂ (HOR on Pt/C cathode) as fuel without any backpressure (1 atm absolute gas pressure) on both sides. The anode bipolar plate is a corrosion-resistant Ti-plate (2×2 mm², single parallel flow channel) to avoid carbon corrosion at high potentials during electrolyzer mode whereas the cathode is a graphite plate (1×1 mm², three serpentine flow channel). The gases are passed at a stoichiometric ratio of 2.0 with a minimum flow rate maintained at 100 ml min⁻¹. The open circuit potential (OCP) is recorded, and the current is scanned from the OCP to a value where the cell voltage drops below 0.2 V (operation is stopped), with each current density maintained for 2 min.

Results and Discussion.

Physical Characterization.

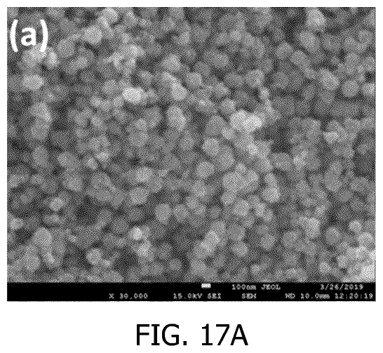

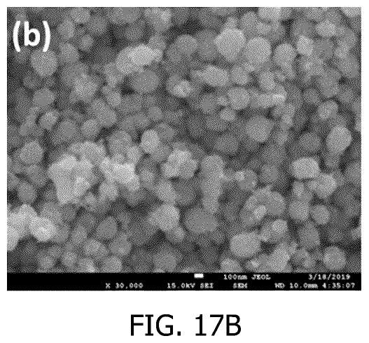

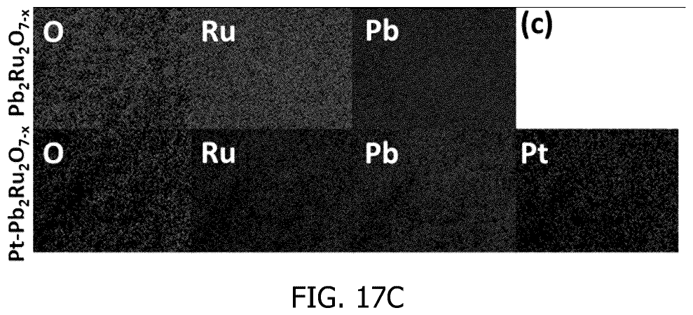

The particle size, surface morphology and elemental composition and mapping are evaluated using scanning electron microscopy coupled with energy dispersive spectroscopy (SEM/EDX). The SEM images reveal that the particle size of Pb₂Ru₂O₇₋ₓ and Pt—Pb₂Ru₂O₇₋ₓ samples are in the range of 70-140 nm and 100-210 nm, respectively (FIGS. 17A-17B). The increase in the particle size for Pt—Pb₂Ru₂O₇₋ₓ as compared to Pb₂Ru₂O₇₋ₓ is attributed to the Pt-deposition as well as additional heating during Pt—Pb₂Ru₂O₇₋ₓ synthesis. Elemental mapping with EDX for Pb₂Ru₂O₇₋ₓ shows the presence of Pb, Ru and O-elements confirming the formation of Pb—Ru oxide system whereas EDX elemental mapping of Pt—Pb₂Ru₂O₇₋ₓ shows the presence of Pt along with Pb, Ru and O-elements confirming Pt-deposited Pb—Ru oxide system (FIG. 17C). The amount of Pt in bulk Pt—Pb₂Ru₂O₇₋ₓ is also determined as ˜5 wt % using EDX.

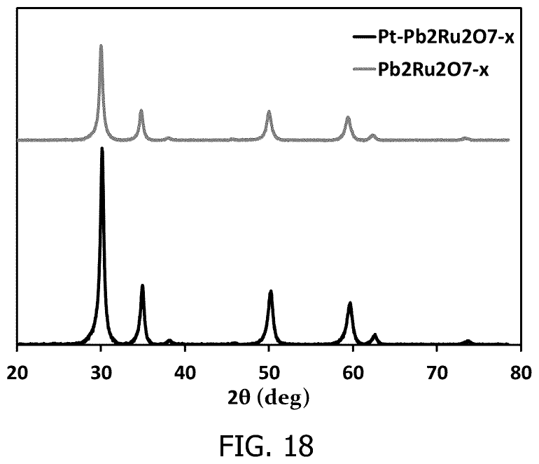

XRD is performed on the Pb₂Ru₂O₇₋ₓ and Pt—Pb₂Ru₂O₇₋ₓ samples to identify the crystal structure (FIG. 18). The XRD peaks for Pb₂Ru₂O₇₋ₓ match with the pyrochlore phase (PDF-00-002-1365, Space-group-Fd-3m) of Pb₂Ru₂O₇(FIG. 18) without any additional peak associated with segregated Ru- and Pb-oxide or any of their mixed oxide phase. The probability of the formation of solid solution or doped oxide is minimal due to high size mismatch of Pb and Ru ions. The Rietveld refinement on Pb₂Ru₂O₇₋ₓ XRD peaks determines a lattice constant of a=b=c=10.325 Å which is similar to other known values. This structure includes structural oxygen defects originating from charge imbalance between multiple oxidation states of Pb(II/IV) and Ru(IV/V). The XRD peaks for Pt—Pb₂Ru₂O₇₋ₓ did not show the presence of prominent additional peaks associated with metallic Pt which may be due to the low concentration (˜5 wt %) and low crystallinity of Pt as against Pb₂Ru₂O₇₋ₓ. The Rietveld refinement on the XRD peaks of Pt—Pb₂Ru₂O₇₋ₓ shows almost no change in the lattice constant (a=b=c=10.325 Å) confirming no lattice expansion or contraction of Pb₂Ru₂O₇₋ₓ. No shift in the peaks (pyrochlore phase) is observed for Pt—Pb₂Ru₂O₇₋ₓ as compared to Pb₂Ru₂O₇₋ₓ confirming no Pt-doping into the Pb₂Ru₂O₇₋ₓ structure (FIG. 18).

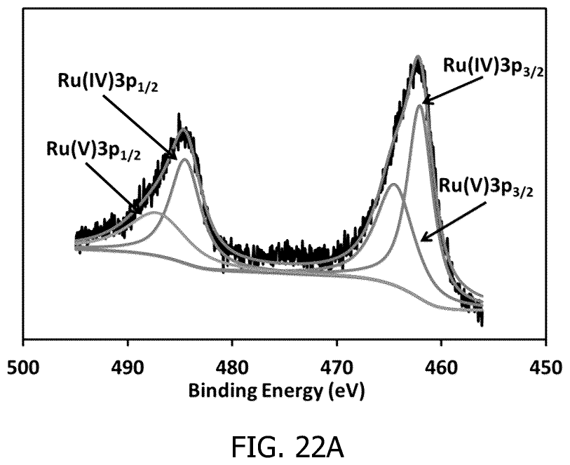

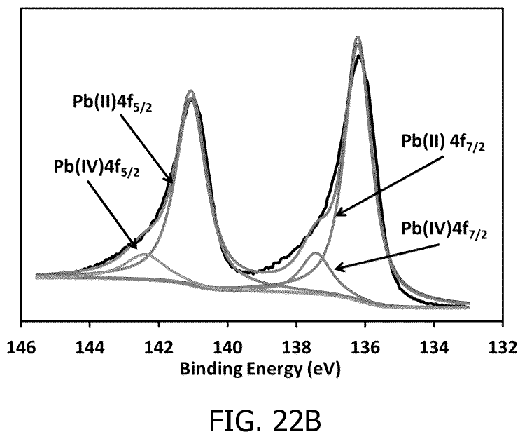

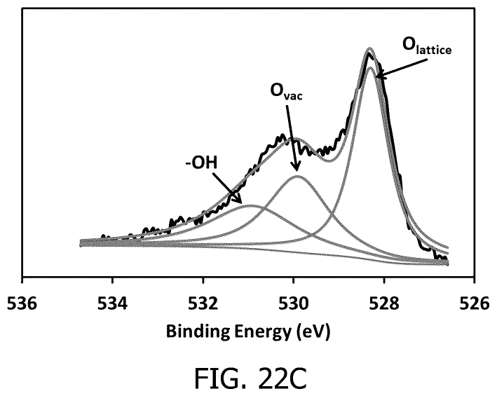

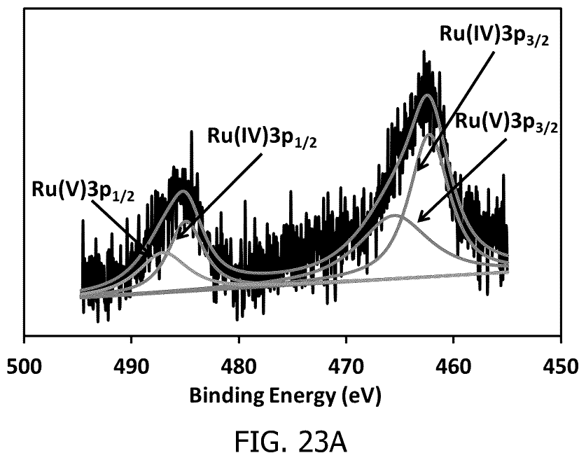

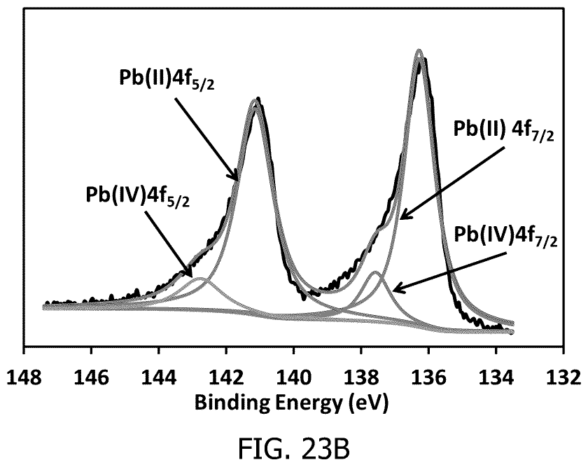

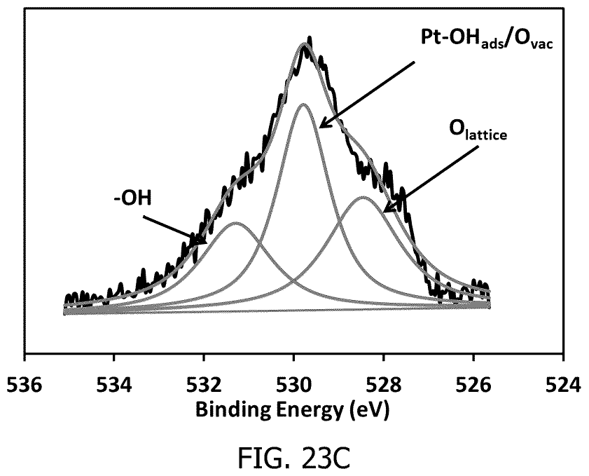

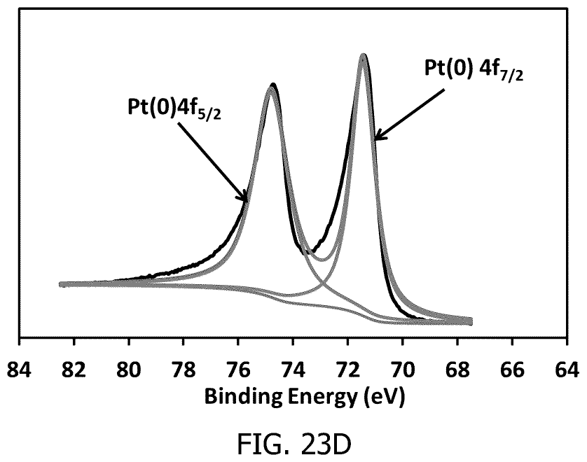

The X-ray photoelectron spectroscopy (XPS) is performed on both Pb₂Ru₂O₇₋ₓ and Pt—Pb₂Ru₂O₇₋ₓ to determine the surface elemental composition and oxidation states of the elements. XPS of Pb₂Ru₂O₇₋ₓ shows multiple oxidation states of Pb and Ru along with the formation of oxygen vacancies. The deconvoluted Pb 4f XPS spectrum of Pb₂Ru₂O₇₋ₓ yields four sub-peaks at ˜136.2 eV, ˜137.3 eV, ˜141.1 eV and ˜142.3 eV corresponding to Pb(II) 4f_{7/2}, Pb(IV) 4f_{7/2}, Pb(II) 4f_{5/2} and Pb(IV) 4f_{5/2}, respectively (FIG. 22A). The peak splitting and peak area ratio (Pb(IV)/Pb(II)) are determined as ˜4.9 eV and ˜0.18 eV, respectively. The deconvoluted Ru 3p XPS spectrum also shows four sub-peaks at ˜462.5 eV, ˜464.8 eV, ˜484.8 eV and ˜487.5 eV that correspond to Ru(IV) 3p_{3/2}, Ru(V) 3p_{3/2}, Ru(IV) 3p_{1/2} and Ru(V) 3p_{1/2}, respectively which is similar to known values (FIG. 22B). The peak splitting and peak area ratio (Ru(V)/Ru(IV)) are determined as ˜22.5 eV and ˜0.80, respectively. The deconvolution of O is spectrum for Pb₂Ru₂O₇₋ₓ generates three sub-peaks at ˜528.3 eV, ˜529.9 eV and ˜531.0 eV corresponding to the O²⁻ state of O-atoms in crystal lattice (O_{lattice}), an auxiliary oxidation state of the O-atom due to the creation of oxygen vacancies (O_{vac}), and the surface —OH state, respectively (FIG. 22C). For Pt—Pb₂Ru₂O₇₋ₓ, the deconvoluted Pb 4f XPS spectrum yields four sub-peaks with peak splitting and peak area ratio of ˜5.0 eV and ˜0.18 which are similar to that of Pb₂Ru₂O₇₋ₓ, confirming no change in pyrochlore structure and metal oxidation states (FIG. 23A). The result is also confirmed by minimal change in peak splitting (˜22.3 eV) and peak area ratio (˜0.78) of Ru 3p XPS spectrum (FIG. 23B). The deconvoluted O 1s XPS peak of Pt—Pb₂Ru₂O₇₋ₓ shows similar sub-peaks as Pb₂Ru₂O₇₋ₓ with higher O_{vac}/O_{lattice} (FIG. 23C). The higher O_{vac}/O_{lattice} for Pt—Pb₂Ru₂O₇₋ₓ(1.32) as compared to Pb₂Ru₂O₇₋ₓ(0.68) is ascribed to the appearance of another peak at ˜529.5 eV associated with the adsorbed —OH on Pt. The deconvolution of Pt 4f XPS peak for Pt—Pb₂Ru₂O₇₋ₓ yields sub-peaks mainly associated with metallic Pt (Pt(0) 4f_{7/2} and Pt(0) 4f_{5/2} at ˜71.5 and ˜74.9 eV, respectively) with a peak orbital splitting of ˜3.4 eV.

Electrochemical Characterization.

There is a lot of ambiguity regarding the choice of the characterization technique which can appropriately quantify the active site density or specific surface area. While BET surface area is used to calculate surface area for gas-phase heterogenous catalysis reactions, its utility for electrochemical reactions is still open to questions. In the case of electrochemical reactions, double-layer capacitance (C_{DL}) is taken as a surrogate for electrochemical surface area and it is quite effective in quantifying active surface area especially for OER. It has been found that BET surface area and ECSA computed through C_{DL} has similar scaling relationship for metal oxide nanoparticles. However, if the electrode material in question is composed of a mixture of materials, then ECSA calculation becomes erroneous due to variety of specific capacitance and dielectric behavior of different materials. For those cases, BET surface area is suitable to calculate specific electrochemical activity. For reduction reactions (e.g. ORR or HER) especially involving Pt-electrocatalyst, hydrogen adsorption-desorption or CO-stripping is being used to quantify the active surface area. Hence, BET surface area are employed to calculate specific OER activity, while both the ECSA computed from H-adsorption/desorption and BET surface area are employed to calculate specific ORR activity.

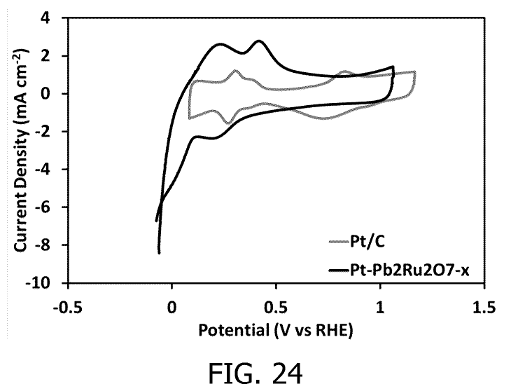

CVs have been performed on both Pt/C and Pt—Pb₂Ru₂O₇₋ₓ in N₂-saturated 0.1 M of KOH to measure Pt-specific ECSA (FIG. 24). For both electrocatalysts, peaks appear signifying hydrogen adsorption/desorption on Pt between 0-0.6 V vs RHE followed by the formation of double-layer at 0.6-0.8 V vs RHE using hydrogen underpotential deposition (H_{upd}) method. With increase in the potential (at 0.8-1.1 V vs RHE), metal surface oxidation and reduction occur during forward and reverse scan, respectively. The Pt-specific ECSA of Pt/C and Pt—Pb₂Ru₂O₇₋ₓ are determined according to the equation S4. Despite of the low Pt-loading of Pt—Pb₂Ru₂O₇₋ₓ(˜5 wt %) as compared to Pt/C (46.5 wt %), the ECSA of Pt—Pb₂Ru₂O₇₋ₓ(135 m² g⁻¹_{Pt}) is higher than that of Pt/C (57 m² g⁻¹_{Pt}). This underlines the better dispersion of Pt achieved on Pb₂Ru₂O₇₋ₓ support through the synthesis protocol as compared to Pt-dispersion in commercial Pt/C electrocatalysts. Additionally, a positive and negative shift are observed for hydrogen desorption peak and hydrogen adsorption peak for Pt—Pb₂Ru₂O₇₋ₓ as compared to Pt/C signifying facile hydrogen adsorption (facilitating ORR).

The C_{DL} of Pt—Pb₂Ru₂O₇₋ₓ and Pb₂Ru₂O₇₋ₓ are found to be 9×10⁻⁷ F and 2.9×10⁻⁶ F, respectively. The Pb₂Ru₂O₇₋ₓ and Pt—Pb₂Ru₂O₇₋ₓ show a BET surface area of 85 m²/g and 50 m²/g, respectively. The surface areas measured from BET and C_{DL} follow similar trend (i.e. Pb₂Ru₂O₇₋ₓ<Pt-Pb₂Ru₂O₇₋ₓ) which is ascribed to increase in particle size of Pb₂Ru₂O₇₋ₓ during Pt-deposition process as confirmed by SEM studies (FIGS. 17A-17C). The discrepancy in the ratio of surface area (BET: C_{DL}) computed for Pt—Pb₂Ru₂O₇₋ₓ and Pb₂Ru₂O₇₋ₓ is due to the different dielectric behavior of Pt and Pb₂Ru₂O₇₋ₓ.

Apparent and Specific Electrochemical Activity.

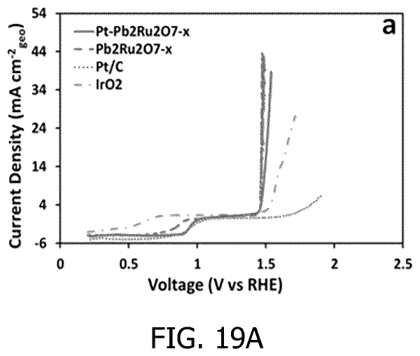

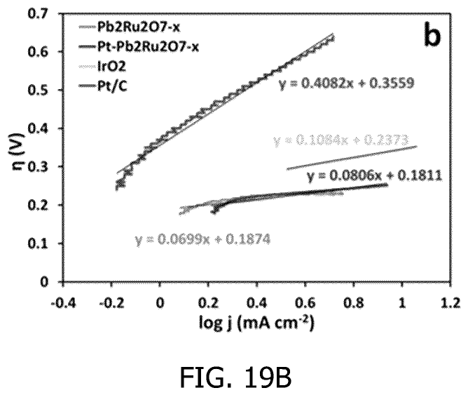

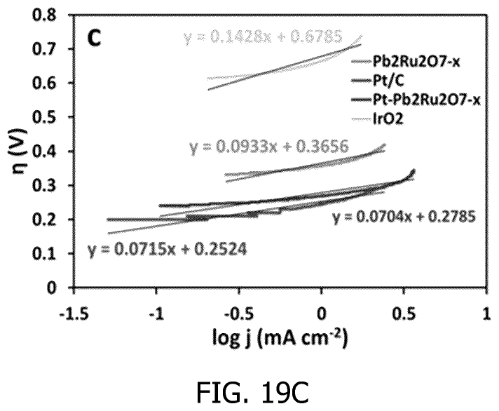

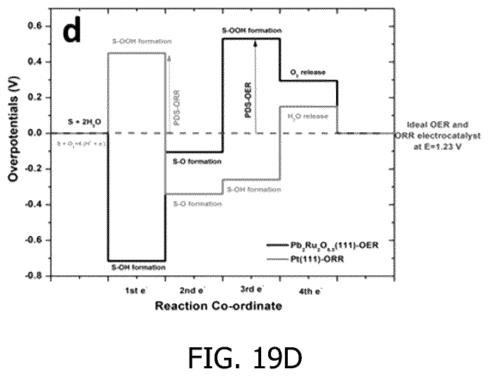

To investigate the applicability of the synthesized electrocatalysts towards the FG-URFC application, LSVs in O₂-saturated 0.1 M KOH solution have been performed to evaluate the ORR and OER activities of the electrocatalysts in a RDE setup (FIGS. 19A-19D). The OER activity is benchmarked by measuring the potential required to reach 10 mA/cm²_{geo} whereas the OER stability is measured by the change in the potential required to reach 10 mA/cm²_{geo} after holding the potential at 1.7 V vs RHE for 2 h. Pt/C does not even reach 10 mA/cm²_{geo} at a voltage up to 1.9 V vs RHE as Pt is not an OER active electrocatalyst which is widely known. Pb₂Ru₂O₇₋ₓ(η_{10 mA/cm2geo}=0.22±0.01 V) shows much higher apparent OER activity as compared to IrO₂ (η_{10 mA/cm2geo}=0.33±0.02 V) (FIGS. 19A-19D, Table 1a). The high apparent OER activity can be ascribed to the high Ru(V)/Ru(IV) ratio (0.67) as confirmed from XPS (FIGS. 22A-22C, 23A-23D). Pt—Pb₂Ru₂O₇₋ₓ shows slightly lower apparent OER activity (η_{10 mA/cm2geo}=0.25±0.01 V) as compared to Pb₂Ru₂O₇₋ₓ which is due to lower surface area and OER-inactive Pt deposition. Apparent OER activity trend is also measured at η_{OER}=0.25 V (1.48 V vs RHE) overpotential for all the electrocatalysts which is in the following order: Pb₂Ru₂O₇₋ₓ>Pt—Pb₂Ru₂O₇₋ₓ>IrO₂>Pt/C. The current density for Pb₂Ru₂O₇₋ₓ at 0.25 V overpotential is 3.91-, 33.1- and 65-fold higher than that for Pt—Pb₂Ru₂O₇₋ₓ, IrO₂ and Pt/C, respectively. The mass-specific and BET-specific OER activities of Pb₂Ru₂O₇₋ₓ, Pt—Pb₂Ru₂O₇₋ₓ, IrO₂ and Pt/C at 1.48 V vs RHE are listed in Table 1a, which shows a trend of Pb₂Ru₂O₇₋ₓ>Pt—Pb₂Ru₂O₇₋ₓ>IrO₂>Pt/C, confirming the excellent OER activity of Pb₂Ru₂O₇₋ₓ and Pt—Pb₂Ru₂O₇₋ₓ.

TABLE 1a
Comparison of OER activity of all the electrocatalysts in 0.1M KOH
in a RDE setup.

| | | Mass specific | | BET specific |
|---|---|---|---|---|
| | | current density | | OER |
| | η@10 | at 1.48 V vs | Tafel | activity |
| | mAcm⁻² | RHE (mA | slope | (mA |
| | (V) | mg⁻¹ catalyst) | (mV/dec) | cm⁻²BET) |
| Pt-Pb₂Ru₂O₇₋ₓ | 0.25 ± 0.01 | 55.1 ± 2.4 | 80.6 ± 1.4 | 0.254 ± 0.01 |
| Pb₂Ru₂O₇₋ₓ | 0.22 ± 0.01 | 215.5 ± 10.1 | 69.9 ± 1.1 | 0.110 ± 0.005 |
| IrO₂ | 0.35 ± 0.02 | 6.5 ± 0.3 | 108.4 ± 2.3 | 0.021 ± 0.001 |
| Pt/C | — | 3.3 ± 0.1 | 408.2 ± 4.2 | 0.001 |

The transition of Ru(V)→Ru(VIII) in Pb₂Ru₂O₇₋ₓ is far less energy intensive in comparison to Ir(IV)→Ir(VIII) in commercial IrO₂, leading to superior specific OER activity of Pb₂Ru₂O₇₋ₓ. The Ru-oxidation state-sensitive-OER activity in Pb₂Ru₂O₇₋ₓ is explained by the stabilization of the higher oxidation state of the surface Ru-atoms that yields to the lowering of the OER activation barrier leading to facile OER. The Ru(V):Ru(IV) ratio remains almost same in Pb₂Ru₂O₇₋ₓ(Ru(V)/Ru(IV)=0.8) and Pt—Pb₂Ru₂O₇₋ₓ(Ru(V)/Ru(IV)=0.78) as confirmed from XPS (FIGS. 22A-22C, 23A-23D), which is responsible for their superior specific activity in comparison to commercial IrO₂.

The Tafel slope is used to understand the mechanistic aspects of the OER mechanism for synthesized Pb₂Ru₂O₇₋ₓ and Pt—Pb₂Ru₂O₇₋ₓ. The Tafel slopes for Pb₂Ru₂O₇₋ₓ and Pt—Pb₂Ru₂O₇₋ₓ are found to be ˜69.9±1.1 mV/dec and −80.6±1.4 mV/dec which indicates that the 3^{rd} electron (S-O+HO⁻→S-OOH+e−) transfer is the potential determining step (PDS) during OER (FIG. 19B). The exchange-current density calculated from Tafel analysis results suggest faster OER kinetics for Pb₂Ru₂O₇₋ₓ(˜27.2±1.3 μA cm⁻²) as compared to Pt—Pb₂Ru₂O₇₋ₓ (˜ 16.5±0.8 μA cm⁻²) despite showing similar PDS which can be ascribed to less active sites due to OER-inactive Pt-deposition. The oxygen vacancies present in Pb₂Ru₂O₇₋ₓ contributes to increase in the OER kinetics through increase in the bulk electronic charge transport (conductivity). However, oxygen vacancies do not take part in PDS as have been shown in the previous studies.

To demonstrate the ORR/OER bifunctional activity, the ORR on all the electrocatalysts have been studied in an O₂-purged 0.1 M KOH solution using LSVs (FIGS. 19A-19D). The apparent ORR activity is benchmarked by the overpotential (η_{-3 mA/cm2geo}) required to reach−3 mA/cm²_{geo} (FIGS. 19A-19D). The apparent ORR activity is found to be in the following order: Pt—Pb₂Ru₂O₇₋ₓ>Pt/C>Pb₂Ru₂O₇₋ₓ>IrO₂ (FIGS. 19A-19D, Table 1b). The higher apparent ORR activity for Pt—Pb₂Ru₂O₇₋ₓ as compared to Pt/C is due to (1) the better Pt-dispersion and subsequent higher ECSA and (2) self-supported electrocatalytic activity of Pt—Pb₂Ru₂O₇₋ₓ. The apparent ORR activity at 0.78 V vs RHE is measured as −4.34±0.02, −3.84±0.05, and −2.79±0.12 mA/cm²_{geo} for Pt/C, Pt—Pb₂Ru₂O₇₋ₓ, and Pb₂Ru₂O₇₋ₓ, respectively. The apparent ORR activity is consisted of an intrinsic kinetic current from O₂ reduction on the surface of the electrocatalyst, and a diffusion-limited current. The ORR activity at higher overpotentials (mass transfer limitation) is limited by the diffusion of O₂ approaching the electrocatalyst surface. Therefore, the diffusion restrictions are decoupled from the observed current density through Koutecký-Levich (K-L) analysis (equation S2). The kinetic current density (iₖ) is calculated for only Pt/C and Pt—Pb₂Ru₂O₇₋ₓ to compare the intrinsic ORR activity of the electrocatalysts as they are the highest ORR active electrocatalysts among all. The ik for Pt—Pb₂Ru₂O₇₋ₓ(7.61±0.13 mA/cm²_{geo}) is found to be greater than that for Pt/C (6.61±0.09 mA/cm²_{geo}) confirming better intrinsic ORR activity of Pt—Pb₂Ru₂O₇₋ₓ as compared to Pt/C. Though the η_{-3 mA/cm2geo}, apparent current density and kinetic current density are good metrics to evaluate the ORR activity, these parameters are greatly influenced by the electrocatalyst surface roughness and deviations in the mass transfer caused by the quality of the drop-casted film. Therefore, to compare the ORR activity, the current is measured at a fixed overpotential (in the kinetic-controlled region) in the polarization curve, followed by normalization using both BET surface area as well as Pt-specific ECSA. The BET surface area-specific ORR activity for both the electrocatalysts is determined as Pb₂Ru₂O₇₋ₓ is also ORR-active. The BET surface area-specific ORR activity of Pt—Pb₂Ru₂O₇₋ₓ and Pt/C are determined as −0.04±0.001 and −0.007±0.001 mA cm⁻²_{BET} at 0.78 V vs RHE, respectively. However, carbon is not ORR-active which makes comprehensive comparison of BET-specific ORR activity of the electrocatalysts difficult and leads to underestimation of specific ORR activity in Pt/C. Therefore, the specific ORR activity of both electrocatalysts is determined based on Pt-specific ECSA. The Pt-specific ECSA of Pt/C and Pt—Pb₂Ru₂O₇₋ₓ are determined as 0.8±0.08 and 2.84±0.14 A m⁻²_{Pt-specific ECSA} at 0.78 V vs RHE, respectively. The results show higher (3.55-fold) Pt-specific ORR activity for Pt—Pb₂Ru₂O₇₋ₓ as compared to Pt/C which offers an excellent ORR activity crucial for FG-URFC application. However, the reported ORR-activity in Pt—Pb₂Ru₂O₇₋ₓ constitutes a combinatorial ORR activity coming out from both Pt and Pb₂Ru₂O₇₋ₓ which may lead to overestimation of specific activity of Pt in Pt—Pb₂Ru₂O₇₋ₓ.

The Tafel analysis of ORR for all the samples is determined in the following order: IrO₂>Pb₂Ru₂O₇₋ₓ>Pt/C>Pt—Pb₂Ru₂O₇₋ₓ(Table 1b). The result indicates highly facile ORR for both Pt/C and Pt—Pb₂Ru₂O₇₋ₓ as compared to IrO₂ and Pb₂Ru₂O₇₋ₓ. The higher Tafel slope for Pt/C as compared to Pt—Pb₂Ru₂O₇₋ₓ indicates more facilitated ORR on Pt—Pb₂Ru₂O₇₋ₓ in comparison to Pt/C. The Tafel slope of Pb₂Ru₂O₇₋ₓ indicates that the 1^{st} electron transfer step involving molecular O₂ dissociation (S+O₂+H₂O+e⁻→S-OOH+OH⁻) on the surface as PDS for the ORR. For both Pt/C and Pt—Pb₂Ru₂O₇₋ₓ, the Tafel slope value signifies 2^{nd} electron transfer (S-OOH+e⁻→S—O+OH⁻) as PDS. The change in the PDS for Pt—Pb₂Ru₂O₇₋ₓ as compared to Pb₂Ru₂O₇₋ₓ is attributed to the deposition of more ORR-active Pt-deposition which controls the ORR activity.

TABLE 1b
Comparison of ORR activity in 0.1M KOH of all the electrocatalysts
in a RDE setup.

| | | Mass specific | | BET specific |
|---|---|---|---|---|
| | | current | | ORR |
| | | density | | activity at |
| | η@3 | at 0.78 V vs | Tafel | 0.78 V vs |
| | mAcm⁻² | RHE (mA | slope | RHE (mA |
| | (V) | mg⁻¹ catalyst) | (mV/dec) | cm⁻²BET) |
| Pt-Pb₂Ru₂O₇₋ₓ | −0.31 ± 0.02 | −19.2 ± 0.26 | 61 ± 1.6 | −0.04 ± 0.001 |
| Pb₂Ru₂O₇₋ₓ | −0.47 ± 0.01 | −13.9 ± 0.61 | 116 ± 3.8 | −0.02 ± 0.001 |
| IrO₂ | −1.03 ± 0.02 | — | 164 ± 2.0 | — |
| Pt/C | −0.33 ± 0.02 | −21.7 ± 0.1 | 71 ± 0.8 | −0.007 ± 0.001 |

DFT-based calculations have been performed on (111) facet of Pb₂Ru₂O_{6.5} and Pt to calculate their OER and ORR overpotentials individually. The surface Pb and Ru atoms of Pb₂Ru₂O_{6.5} (111) facet become covered by O-atoms before OER sets in (FIG. 19D). The OER overpotential is found to be 0.52 V considering surface Ru as an active site with 3^{rd} electron transfer being the potential determination step (PDS). The ORR overpotential on Pt(111) facet is found to be 0.45 V which is close to known values.

Electrochemical Stability.

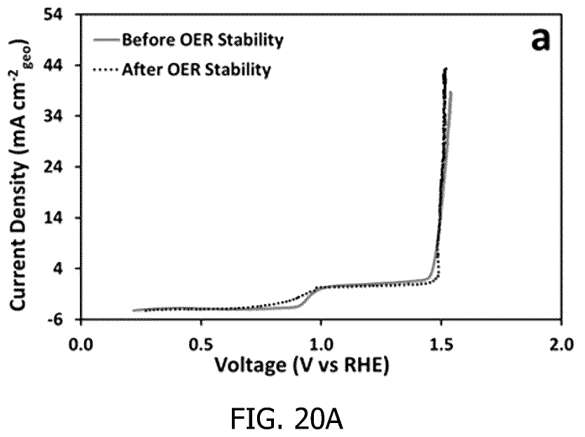

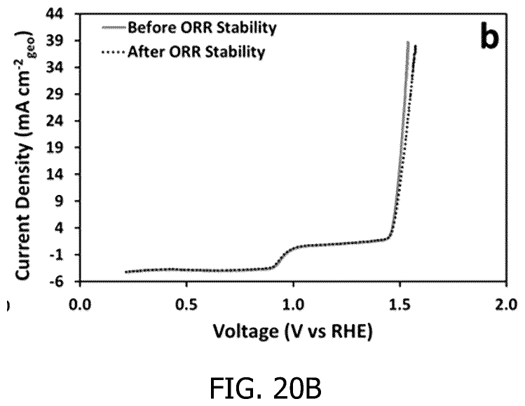

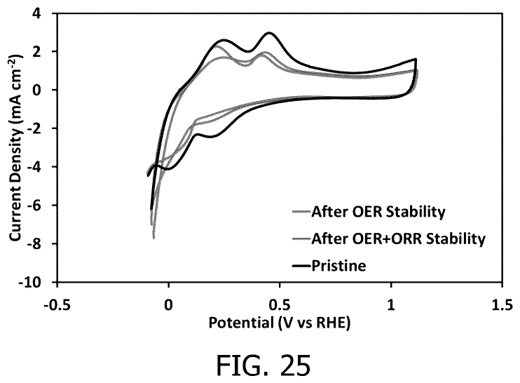

The OER stability of Pt—Pb₂Ru₂O₇₋ₓ is studied using potentiostatic-hold that operates at the potential of 1.7 V vs RHE for 2 h. LSVs have been performed before and after the potentiostatic-hold test and both the OER and ORR activity of Pt—Pb₂Ru₂O₇₋ₓ are compared (FIG. 20A). Pt—Pb₂Ru₂O₇₋ₓ shows no change in OER overpotential (η_{10 mAcm-2,2 h}=0.26±0.01 V) after the OER-hold test, confirming high stability of Pt—Pb₂Ru₂O₇₋ₓ in alkaline medium under OER condition. However, it shows a 0.12 V increase in the ORR overpotential (η_{-3 mAcm-2,2 h}=−0.43±0.01 V) after the OER-hold test. The increase in the ORR overpotential is due to the formation of passivated Pt-oxide (ORR-inactive) in Pt—Pb₂Ru₂O₇₋ₓ which is not fully transformed to Pt during ORR (FIG. 25). Additionally, the oxygen vacancies in Pb₂Ru₂O₇₋ₓ are quenched during OER which are responsible for promoting ORR, thereby further lowering the activity. The results also confirm that Pb₂Ru₂O₇₋ₓ in Pt—Pb₂Ru₂O₇₋ₓ is mostly responsible for the OER activity with minimum contribution from Pt. Pt—Pb₂Ru₂O₇₋ₓ do not follow the inverse activity-stability relationship which is commonly found for single crystal Ru(0001) or RuO₂(110). Surface Ru-atoms in Pb₂Ru₂O_{6.5}, Ln₂Ru₂O₇ (Ln=lanthanide elements) or doped oxides (e.g. dimensionally stable anodes) do not show the traditional low stability behavior found in single crystals of Ru(0001) or RuO₂(110) as the formation of RuO₄ or its hydrated form, is avoided in the pyrochlore system through charge-compensation of Ru-atoms with their neighboring Pb-atoms.

The ORR stability of Pt—Pb₂Ru₂O₇₋ₓ is also studied using potentiostatic-hold at the potential of 0.5 V vs RHE for 2 h. Similar to OER stability, LSVs have been performed before and after the ORR-hold test and both the OER and ORR activity of Pt—Pb₂Ru₂O₇₋ₓ are compared (FIG. 20B). Pt—Pb₂Ru₂O₇₋ₓ shows no change in both OER (η_{10 mAcm-2,2 h}=0.26±0.01 V) as well as ORR overpotential (η_{-3 mAcm-2,2 h}=−0.31±0.02 V) after the ORR-hold test, confirming high stability of Pt—Pb₂Ru₂O₇₋ₓ in alkaline medium under ORR condition. However, there is a small decrease in the OER activity for Pt—Pb₂Ru₂O₇₋ₓ at higher potentials after the ORR-hold test which may be due to the surface reduction (lower oxidation states of the metal cations) of Pb₂Ru₂O₇₋ₓ(OER-active). ICP-OES does not detect any Ru in the solution after the OER-hold as well as ORR-hold tests for Pb₂Ru₂O₇₋ₓ and Pt—Pb₂Ru₂O₇₋ₓ samples.

Bifunctional Activity.

The OER/ORR bifunctional activity is benchmarked using BI. The BI of benchmark OER (IrO₂) and ORR (Pt/C) catalyst is greater than 1.0 V which makes them incompatible for use in URFC (Table 2). Pb₂Ru₂O₇₋ₓ exhibits a BI of 0.69 V. However, BI does not clearly represent the effect of individual OER and ORR activity. For example, the activity of Pb₂Ru₂O₇₋ₓ is skewed towards OER as compared to ORR, making its BI low. Pt—Pb₂Ru₂O₇₋ₓ shows a much lower BI (0.56 V) with more symmetric OER-ORR activity profile as compared to Pb₂Ru₂O₇₋ₓ making it more useful for the alkaline-URFC or metal air battery applications. Furthermore, the BI is lower than the best reported bifunctional OER/ORR electrocatalyst (La_{0.8}Ca_{0.2}MnO₃) to date by 0.11 V, thereby underlining its superior performance (Table 2).

TABLE 2
Activity of some of the state-of-the-art bifunctional catalysts.

| | ORR(V) | OER (V) | |
|---|---|---|---|
| | @ | −3 @ 10 | |
| Catalysts | mA/cm²_{geo} | mA/cm²_{geo} | BI (V) |
| La_{0.8}Ca_{0.2}MnO₃ | 0.89 | 1.56 | 0.67 |
| Nd_{1.5}Ba_{1.5}CoFeMnO_{9-δ} | 0.89 | 1.59 | 0.70 |
| hybridized with N-doped r-GO | | | |
| α-MnO₂ | 0.76 | 1.72 | 0.96 |
| RuO₂/C | 0.68 | 1.62 | 0.94 |
| CoO | 0.87 | 1.57 | 0.70 |
| Pt/C | 0.89 | 1.69 | 0.80 |
| ¹Pb₂Ru₂O₇₋ₓ | 0.74 | 1.43 | 0.69 |
| IrO₂ | 0.2 | 1.58 | 1.38 |
| ¹Pb₂Ru₂O₇₋ₓ | 0.76 | 1.45 | 0.69 |
| ¹Pt-Pb₂Ru₂O₇₋ₓ | 0.92 | 1.48 | 0.56 |

^{l}in accordance with the present disclosure

While Pb₂Ru₂O₇₋ₓ show high OER activity, it shows moderate ORR activity. On the other hand, despite showing excellent ORR activity, Pt transforms to PtO₂ after 1.3 V vs RHE during OER thereby reducing its stability and activity. A reduction of overpotential of PDS in Pb₂Ru₂O₇₋ₓ and replacement of Pt with more OER-stable ORR-active electrocatalyst will improve the bifunctional oxygen electrocatalytic properties required for FG-AEMFCs.

FG-URFC Performance.

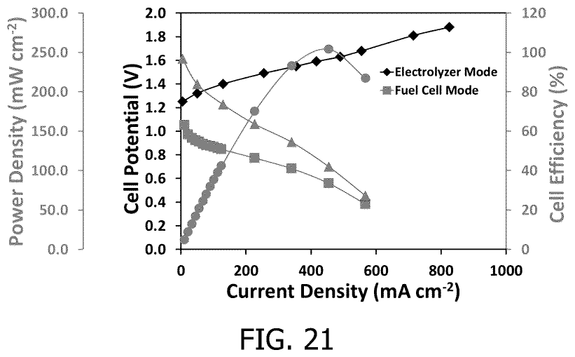

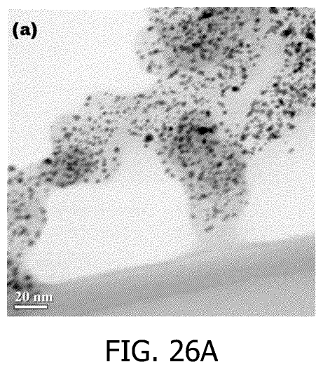

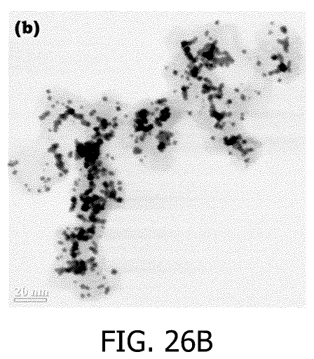

After demonstrating the excellent bifunctional ORR/OER activity of Pt—Pb₂Ru₂O₇₋ₓ vis-a-vis Pb₂Ru₂O₇₋ₓ, Pt/C, and IrO₂ in a RDE setup, fabricated MEAs (5 cm²) were fabricated using Pt—Pb₂Ru₂O₇₋ₓ(1.0 mg cm⁻²) as anode and Pt/C (0.5 mg_{Pt} cm⁻²) as cathode for FG-URFC application (FIG. 21). The performance of the FG-URFC is evaluated at 80° C. under both WE and FC mode (FIG. 21). The FG-URFC shows an excellent FC performance of ˜56±2 mA cm⁻² at 0.9 V (kinetic controlled region) and ˜450±7 mA cm⁻² at 0.5 V (mass-transfer controlled region). The FG-URFC also shows an excellent WE performance of ˜715±11 mA cm⁻² at 1.8 V. The result shows much higher performance for both WE and FC mode as compared to known studies (Table 3). A proper comparison of the URFC performances is not possible due to the difference in the MEA fabrication parameters (e.g. anode and cathode catalyst loading, separator type, binder type, binder to catalyst ratio) operating condition (this disclosure: 80° C. and known work: 20-65° C.). The mass specific current density under WE mode is determined as 715±11 A g_{cat}⁻¹ at 1.8 V. The mass specific and Pt-specific current density of the FG-URFC under FC mode (kinetic controlled region) is determined as 56±2 A g_{cat}⁻¹ and 1120±40 A g_{Pt}⁻¹ at 0.9 V. The RTE for the FG-URFC is determined as ˜84%, ˜75% and ˜40% at 0.05, 0.1 and 0.5 A cm⁻², respectively which is much higher than that any reported value to date (Table 3). However, after 10 consecutive URFC cycles (electrolyzer+fuel cell), the RTE is reduced from ˜84% to ˜70% at 0.05 A cm⁻² and from ˜75% to ˜57% at 0.1 A cm⁻² which may be attributed to a combination of membrane (AEM) degradation and surface oxidation of Ti gas-diffusion layer leading to electrical contact issues (FIG. 25). The TEM images show agglomeration of Pt due to 10 consecutive URFC cycle which is also one of the factors for the AEM-FG-URFC performance loss (FIGS. 26A-26B). The agglomeration is because of dissolution of Pt-particles in WE-mode followed by its re-deposition mode in the FC-mode. Therefore, this disclosure achieves a good initial AEM FG-URFC performance with high RTE for low PGM loading both on anode and cathode side.

TABLE 3
Comparison of alkaline FG-URFC performances.

| | | | Temp | PPD | |
|---|---|---|---|---|---|
| BHE* | BOE* | GDL* | (° C.) | (mWcm⁻²) | RTE(%) |
| 50 wt % | Cu_{0.6}Mn_{0.3}Co_{2.1}O₄ | Carbon | 40 | 80 | 31.9% |
| Pt/C | (3 mg cm⁻²) | paper | | | @100 |
| (1 mg cm⁻²) | | (BHE | | | mA |
| | | & BOE) | | | cm⁻² |
| 20 wt % | Cu_{0.6}Mn_{0.3}Co_{2.1}O₄ | Au-coated | 22 | 114 | 34% |
| Pt/C | (3 mg cm⁻²) | Ti-mesh | | | @100 |
| (0.1 mg | | BHE & | | | mA |
| cm⁻²) | | BOE) | | | cm⁻² |
| Ni/C | Ni/C + MnOₓ/GC | Carbon | 65 | 16.5 | 40% |
| (6 mg | (1:5 by mass, 4 | paper | | | @10 |
| cm⁻²) | mg cm⁻²) | (BHE | | | mA |
| | | & BOE) | | | cm⁻² |
| 46 wt % | MnOₓ | Carbon | 55 | 27 | 2-45% |
| Pt/C | (0.3 mg cm⁻² | paper | | | @20 |
| (0.5 mg | | (BHE) | | | mA |
| cm⁻²) | | Stainless | | | cm⁻² |
| | | steel | | | |
| | | (BOE) | | | |
| 46 wt % | ¹Pt-Pb₂Ru₂O₇₋ₓ | Carbon | 80 | 253 | 75% |
| Pt/C | (1.0 mg cm⁻²) | paper | | | @100 |
| (0.5 mg | | (BHE) | | | mA |
| cm⁻²) | | Ti-plate | | | cm⁻² |
| | | (BOE) | | | |
| 46 wt % | ¹Pt-Pb₂Ru₂O₇₋ₓ | Carbon | 80 | 253 | 40% |
| Pt/C | (1.0 mg cm⁻²) | paper | | | @500 |
| (0.5 mg | | (BHE) | | | mA |
| cm⁻²) | | Ti-plate | | | cm⁻² |
| | | (BOE) | | | |

*BHE = bifunctional hydrogen electrocatalyst,
*BOE = bifunctional oxygen electrocatalyst,
*PPD = peak power density
^{l}in accordance with the present disclosure

Characterization Techniques.

Analytical Characterization.

Scanning electron microscopy (SEM) coupled with energy dispersive spectroscopy (EDX) (JEOL JSM-7001 LVF Field Emission SEM) is used to determine the particle size, elemental composition and mapping of both Pb₂Ru₂O₇₋ₓ and Pt—Pb₂Ru₂O₇₋ₓ. Transmission electron microscopy (TEM) (FEI Tecnai G2 Spirit) is performed to determine the particle size of Pb₂Ru₂O₇₋ₓ and Pt—Pb₂Ru₂O₇₋ₓ. Crystallite phases and lattice constants for Pb₂Ru₂O₇₋ₓ and Pt—Pb₂Ru₂O₇₋ₓ are determined using X-ray diffraction (XRD) (Bruker d8 advance X-ray diffractometer). The scanning is swept from 20-80° (2θ) at a rate of 0.5° per min. Rietveld refinement is performed on XRD peaks to determine the lattice constants of Pb₂Ru₂O₇₋ₓ and Pt—Pb₂Ru₂O₇₋ₓ. X-ray photoelectron spectroscopy (XPS) is performed on Pb₂Ru₂O₇₋ₓ and Pt—Pb₂Ru₂O₇₋ₓ using 5000 VersaProbe II Scanning ESCA Microprobe with Al K-alpha X-ray source to determine the surface elemental composition and the oxidation states of elements. Inductive coupled plasma-optical emission spectroscopy (ICP-OES, PerkinElmer 7300 DV) has been performed to monitor the dissolution of Ru from both Pb₂Ru₂O₇₋ₓ and Pt—Pb₂Ru₂O₇₋ₓ(detection limit: ˜0.1 ppm).

Electrochemical Characterization.

The electrochemical ORR and OER activity of commercial Pt/C (ORR), commercial IrO₂ (OER), Pb₂Ru₂O₇₋ₓ, and Pt—Pb₂Ru₂O₇₋ₓ is determined using a rotating disk electrode (RDE) setup technique. The catalyst inks for all the electrocatalysts are prepared by ultrasonication (QSonica; Q700 sonicator) of a mixture (sonication ON=1 min. and sonication OFF=30 sec.) containing 25 mg catalyst, 6 mL of 24% (vol/vol) isopropanol/water, 0.275 mL of Nafion® solution (Sigma Aldrich; 5 wt % solution in aliphatic alcohols) and 0.250 mL of 1 M KOH for 10 min similar to a previous method. The KOH solution is added to neutralize the acidity of Nafion® as Pb₂Ru₂O₇₋ₓ is not stable for long time durations in acidic medium. To prepare RDE setup, a glassy carbon (GC) electrode (geometric area=0.196 cm²) is polished on a polishing pad with 0.05 μm alumina slurry (Pine Instruments) for 10 min to achieve a mirror-like finish. Then, a 10 μL of well-dispersed homogeneous catalyst ink is drop-casted onto the freshly polished GC electrode which is dried by rotating the RDE rotor in an inverted position at 400 rpm to ensure a uniform distribution and avoid agglomeration of the electrocatalysts throughout the electrode surface. The catalyst loading is achieved as 200 μg cm⁻²_{disk}. The catalyst loading used for both Pt/C and Pt— Pb₂Ru₂O₇₋ₓ is 0.2 mg cm⁻² which translates into Pt-loading of 0.01 mg and 0.09 mg in Pt— Pb₂Ru₂O₇₋ₓ and Pt/C, respectively. The RDE experiments are performed in a conventional three-electrode setup with catalyst loaded GC, Pt mesh and Ag/AgCl/(saturated KCl) as working, counter and reference electrode, respectively. Linear sweep voltammetry (LSV) is performed by sweeping the potential at a scan rate of 20 mV s⁻¹ using a Gamry potentiostat.

For OER, LSV is performed in a 0.1 M KOH electrolyte under continuous oxygen purging. The LSVs are corrected for potential (iR) drop and reported with respect to reversible hydrogen electrode (RHE). The potential is converted to the RHE scale after taking into account the pH correction and relative correction for the Ag/AgCl reference electrode. The potential is swept anodically to determine the OER activity in 0.1 M KOH solution at 1600 rpm. All the LSV scans are corrected by subtracting the capacitive currents measured at 0.97-1.25 V vs RHE (non-faradaic region). The OER experiments are not performed at different rotation rates as OER is not a mass transfer-controlled reaction.

The same methodology for ink preparation, catalyst deposition, and actual potential calculation via iR drop correction are used during ORR as in OER. However, the potential is swept cathodically (in the negative direction) for ORR at different rotation rates since ORR is a mass transfer-controlled reaction. The experiment is performed in both O₂- and N₂-purged environments. The ORR LSV scans are corrected by subtracting the current in N₂-purged solution from the currents for O₂-purged environment. The Koutecky-Levich (K-L) equation is used to calculate the kinetic current during ORR by running the LSVs at different rotation rates of 400, 900, 1600 and 2500 rpm.

$$\frac{1}{i} = \frac{1}{{i}_{k}} + \frac{1}{{i}_{L}} \qquad ( S1 )$$

Where, i is the observed current from LSV, iₖ and i_{L} are the kinetic and diffusion-limited current, respectively.

The double layer capacitance (C_{DL}) which is a surrogate for ECSA (electrochemically active surface area) is measured for all the synthesized electrocatalysts by using cyclic voltammetry (CV) at different scan rates (ν=5, 10, 20 and 50 mV/s) by scanning at a potential range of −0.31-0.0 V vs Ag/AgCl. The C_{DL} is determined using the following equation.

i=C_{DL}×ν (S2)

CVs are also performed on both Pt/C and Pt—Pb₂Ru₂O₇₋ₓ in N₂-saturated 0.1 M of KOH to determine the Pt-specific ECSA. The CVs are employed by scanning the potential between −1.1 V-0.15 V vs Ag/AgCl under a scan rate of 20 mV s⁻¹. The ECSA of the Pt-based catalysts are determined using the following equation.

$$ECSA = \frac{{Q}_{H - ads}}{210 {L}_{P t} {A}_{g}} \qquad ( S3 )$$

Where, Q_{H-ads} is the underpotential hydrogen adsorption/desorption charge calculated from the CVs, L_{Pt} is the Pt loading (mg_{Pt}·cm⁻²) on the GC electrode, the amount of charge transferred with monolayer adsorption (210 ρC cm⁻²) and A_{g} (cm²) is the geometric surface area of the GC electrode.

The OER hold-test of Pt—Pb₂Ru₂O₇₋ₓ is performed by using chronoamperometry at a constant potential of 1.7 V vs RHE under O₂-purging at 1600 rpm for 2 h in 0.1 M KOH solution. ORR hold-test of the electrocatalyst is also performed on Pt—Pb₂Ru₂O₇₋ₓ by applying 0.5 V vs RHE (chronoamperometry) for 2 h in 0.1 M KOH under continuous oxygen purging at 1600 rpm. LSVs are also performed before and after the hold-test (ORR and OER) to show the long-term effect of ORR and OER on Pt—Pb₂Ru₂O₇₋ₓ.

ORR Performance and ECSA Measurement During Combined OER-ORR Hold Test.

ORR of Pt—Pb₂Ru₂O₇₋ₓ has been performed before the start of hold, after a 2 h OER-hold test and then 2 h ORR-hold test. After each of the hold cycles, ECSA is measured through H-UPD measurement. The ECSA of Pt—Pb₂Ru₂O₇₋ₓ as measured through H-UPD decreases in comparison to its pristine state upon an OER-hold test because of the formation of Pt-oxide (FIG. 25). After the ORR-cycle, the ECSA of Pt—Pb₂Ru₂O₇₋ₓ increases though it does not recover all the active sites indicating that PtO₂→Pt transformation is incomplete (FIG. 25).

Computational Methods.

All the calculations related to Density Functional Theory (DFT) has been done using Vienna Ab Initio Simulation package (VASP) and PBE pseudo-potential. The bulk lattice constants of Pb₂Ru₂O_{6.5} and Pt are optimized using a Monkhorst-Pack type of k-point sampling of 8×8×8 encompassing the reciprocal space. An energy cut-off of 520 eV is employed during energy minimization of the bulk structure. Geometry optimizations for the structures were carried out until the maximal force acting on each atom became less than 0.02 eV/Å. The bulk lattice constant of Pb₂Ru₂O_{6.5} is found to be a=b=c=10.29 Å, as against experimentally found values of a=b=c=10.325 Å. The bulk lattice constant of Pt is found to be a=b=c=3.968 Å, as against experimentally reported values of a=b=c=3.924 Å.

The (111) facet of Pb₂Ru₂O_{6.5} and Pt are optimized using a Monkhorst-Pack type of k-point sampling of 4×4×1 encompassing the reciprocal space. A vacuum slab of 15 Å is considered during calculation. The computational hydrogen electrode, described by Nørskov, has been used to represent the data on the standard hydrogen electrode (SHE) scale unless otherwise stated.

The following assumptions are made to simplify electrochemical reactions:

1. The chemical potential of (H⁺+e⁻) pair is related to that of ½ H₂ in the gas-phase via the normal hydrogen electrode (NHE) at U=0 V which leads to the relation,

G(H⁺)=0.5G(H₂)

2. The free energy of the reaction intermediates are calculated via DFT by also including the zero-point energy (ZPE) and vibrational contributions. The gas-phase molecules are assumed to behave like an ideal gas with the appropriate translation and rotational contribution.

3. The effect of bias on all states involving an electron in the electrode can be included by shifting the reaction step by −eU where U is the applied electrochemical potential.

All the adsorption energies were calculated with respect to gaseous H₂ and H₂O vapor at 298 K and 0.035 bar.

The energy barriers for OER and ORR are calculated considering a known reaction mechanism suggested by Nørskov et al.

Efficiency Calculation.

Round-trip efficiency (RTE) at different current densities is determined using the following equation,

RTE(%)=WE_{efficiency}×FC_{efficiency} (S4)

Where, FC_{efficiency} is fuel cell efficiency and WE_{efficiency} is the water electrolyzer efficiency. The fuel cell efficiency at a given current density is calculated according to the equation,

$${FC}_{efficiency} = \frac{{V}_{observed}}{{E}_{reversible} ( T , P )} \times 100 \% \qquad ( S5 )$$

Where, E_{reversible}(T, P) is determined as 1.168 V at the operating condition and V_{observed} is the measured cell potential at a given current density.

An extra 0.252 V needs to be added to E_{reversible}(T, P) for water electrolyzer as energy requirement for a mole of H₂/O₂ production via a mole of liquid water splitting at 25° C. is supplied by electricity as well as heat.

Therefore, the electrolyzer efficiency is calculated according to the following equation,

$${WE}_{efficiency} = \frac{1.42}{{V}_{observed}} \times 100 \% \qquad ( S6 )$$

### CONCLUSIONS

The performance of fixed-gas unitized regenerative fuel cells (FG-URFCs) are limited by the bifunctional activity of the oxygen electrocatalyst. It is essential to have a good bifunctional oxygen electrocatalyst which can exhibit high activity for oxygen evolution reaction (OER) and oxygen reduction reaction (ORR). In this regard, Pt—Pb₂Ru₂O₇₋ₓ is synthesized by depositing Pt on Pb₂Ru₂O₇₋ₓ wherein individually Pt exhibits high ORR while Pb₂Ru₂O₇₋ₓ shows high OER and moderate ORR activity. Pt—Pb₂Ru₂O₇₋ₓ exhibits higher OER (η_{@10 mAcm-2}=0.25±0.01 V) and ORR (η_{@-3 mAcm-2}=−0.31±0.02 V) activity in comparison to benchmark OER (IrO₂, η_{@10 mAcm-2}=0.35±0.02 V) and ORR (Pt/C, η_{@-3 mAcm-2}=−0.33±0.02 V) electrocatalysts, respectively. Pt—Pb₂Ru₂O₇₋ₓ shows a lower bifunctionality index (η_{@10 mAcm-2, OER}−η_{@-3 mAcm-2, ORR}) of 0.56 V with more symmetric OER-ORR activity profile than both Pt (>1.0 V) and Pb₂Ru₂O₇₋ₓ (0.69 V) making it more useful for the AEM (anion exchange membrane)-URFC or metal-air battery applications. FG-URFC tested with Pt—Pb₂Ru₂O₇₋ₓ and Pt/C as bifunctional oxygen electrocatalyst and bifunctional hydrogen electrocatalyst, respectively yields a mass-specific current density of 715±11 A g_{cat}⁻¹ at 1.8 V and 56±2 A g_{cat}⁻¹ at 0.9 V under electrolyzer mode and fuel cell mode, respectively. The FG-URFC shows a round-trip efficiency (RTE) of 75% at 0.1 A cm⁻², underlying improvement in AEM FG-URFC electrocatalyst design.

In conclusion, Pt has been deposited on Pb₂Ru₂O₇₋ₓ which shows a record low BI of 0.56 V with more symmetric OER-ORR activity profile which makes it useful for the alkaline-URFC or metal air battery applications. Pt—Pb₂Ru₂O₇₋ₓ exhibits higher OER and ORR activity in comparison to benchmark OER (i.e. commercial IrO₂) and ORR (i.e. commercial Pt/C) electrocatalysts, respectively. The increased OER activity is ascribed to a high Ru(V):Ru(IV) ratio in Pt—Pb₂Ru₂O₇₋ₓ which is confirmed through XPS study. The high ORR activity of Pt—Pb₂Ru₂O₇₋ₓ is due to the high dispersion of Pt on Pb₂Ru₂O₇₋ₓ in Pt—Pb₂Ru₂O₇₋ₓ which is confirmed through ECSA measurement. Furthermore, Pt—Pb₂Ru₂O₇₋ₓ shows no change in OER and ORR-activity after a 2 h ORR-hold test experiment underlying its long-term stability in alkaline-ORR conditions. Additionally, Pt—Pb₂Ru₂O₇₋ₓ exhibits an unchanged OER activity after OER-hold test for 2 h. However, it shows a reduction of 0.12 V in the ORR overpotential after the OER-hold test due to the formation of passivated Pt-oxide. A FG-URFC tested with Pt—Pb₂Ru₂O₇₋ₓ and Pt/C as bifunctional oxygen electrocatalyst and bifunctional hydrogen electrocatalyst, respectively yields a mass-specific current density of 715±11 A g⁻¹ at 1.8 V and 56±2 A g_{cat}⁻¹ at 0.9 V under electrolyzer mode and fuel cell mode, respectively. The FG-URFC shows a round-trip efficiency (RTE) of 75% at 0.1 A cm⁻² which is the highest reported RTE in an alkaline FG-URFC to date. Therefore, Pt—Pb₂Ru₂O₇₋ₓ as OER/ORR bifunctional electrocatalyst with a low bifunctional index, leads to significant improvement on electrocatalyst design and demonstrates increased viability of alkaline FG-URFCs.

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed disclosure. The term “consisting essentially of” occupies a middle ground between “comprising” and “consisting of”.

Where a disclosure or a portion thereof is defined with an open-ended term such as “comprising,” it should be readily understood that (unless otherwise stated) the description should be interpreted to also describe such a disclosure using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the disclosure are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

What is claimed is:

1. An electrolytic cell comprising:
a cathode;
an anode comprising a pyrochlore comprising a metal deposited thereon; and
an ion exchange membrane separating the cathode and the anode.

2. The electrolytic cell of claim 1, wherein the electrolytic cell is a unitized regenerative fuel cell.

3. The electrolytic cell of claim 1, wherein the electrolytic cell is a fixed gas unitized regenerative fuel cell.

4. The electrolytic cell of claim 1, wherein the pyrochlore is a compound according to Formula I:
A¹ₓA²₂₋ₓB¹_{y}B²_{2-y}O_{7-z} (I),
wherein
A¹ and A² are each independently selected from the group consisting of Pb, Y, La, Gd, Bi, Dy, Cd, Tl, and Ca;
B¹ and B² are each independently selected from the group consisting of Ru, Ir, Rh, Re, Sn, Ti, Pt, Os, Zr, and Pd;
x is a value between 0 and 2;
y is a value between 0 and 2; and
z is a value between 0 and 1.

5. The electrolytic cell of claim 1, wherein the pyrochlore is essentially free of Bi.

6. The electrolytic cell of claim 1, wherein the metal is selected from the group consisting of Ru, Ir, Rh, Re, Sn, Ti, Pt, Os, Zr, and Pd.

7. The electrolytic cell of claim 1, wherein the cathode comprises a catalyst selected from the group consisting of Pt, Pd, alloys of Pt and alloys of Pd supported on C, RuO₂, Ni(OH)₂, TiO₂, SnO₂, TiO₂ with Nb or Ru dopants, SnO₂ with Sb or Ta dopants, and combinations thereof.

8. The electrolytic cell of claim 1, wherein the ion exchange membrane is selected from the group consisting of an anion exchange membrane and a proton exchange membrane.

9. An electrolyzer comprising the electrolytic cell of claim 1.

10. A fuel cell comprising the electrolytic cell of claim 1.

11. The fuel cell of claim 10, wherein the fuel cell is a fixed-gas unitized regenerative fuel cell.

12. A method of using an electrolytic cell, the method comprising:
using the electrolytic cell as an electrolyzer and/or a fuel cell;
wherein the electrolytic cell comprises:
a cathode;
an anode comprising a pyrochlore comprising a metal deposited thereon; and
an ion exchange membrane separating the cathode and the anode.

13. The method of claim 12, wherein the method comprises using the electrolytic cell as an electrolyzer.

14. The method of claim 12, wherein the method comprises electrolyzing water.

15. The method of claim 12, wherein the method comprises electrolyzing brine.

16. The method of claim 12, wherein the method comprises using the electrolytic cell as a fuel cell.

17. The method of claim 12, wherein the method comprises supplying an oxidant and a fuel source to the electrolytic cell.

18. The method of claim 17, wherein the oxidant is O₂.

19. The method of claim 17, wherein the fuel source is H₂.

20. The method of claim 11, wherein the electrolytic cell is a fixed-gas unitized regenerative fuel cell.
